(19) United States
(12) Patent Application Publication
(10) Pub. No.: US 2018/0232779 A1
(43) Pub. Date: Aug. 16, 2018

(54) MULTI-TENANT PUBLISHING SYSTEM

(71) Applicant: AdvisorDeck, LLC, San Francisco, CA (US)

(72) Inventors: Cameron Nordholm, Menlo Park, CA (US); Cristin-Alexandru Iosif, Bucharest (RO)

(21) Appl. No.: 15/536,912

(22) PCT Filed: Dec. 19, 2014
(86) PCT No.: PCT/US14/71706

§ 371 Date: Jun. 16, 2017

(51) Int. Cl. G06Q 30/02; G06Q 40/06

(52) U.S. Cl. CPC G06Q 30/0271; G06Q 40/06; G06Q 30/0277

(57) ABSTRACT

In various example embodiments, a system and method for publishing uploaded compliant content are presented. In one embodiment, a scope is defined related to the sharing of uploaded compliant content by individual subscribers of a multi-tenant publishing system based on metadata associated with the individual subscribers. In a further embodiment, engagement activity of the individual subscribers who have access to the uploaded compliant content related to the re-sharing of the uploaded compliant content is managed based on corporate policies governing the individual subscribers.

### BACKGROUND

Financial companies are considered to have one of the most complex sales and marketing structures of any industry. One of the reasons for the complexity in marketing financial services is that there are numerous ways to reach the end customer. For example, retirement services are offered by banks, brokerages, mutual funds, insurance companies, and independent advisors.

Financial services is a highly regulated industry with regulatory constraints that affect numerous marketing decisions. Financial services companies must comply with general advertising guidelines prohibiting advertising that is untruthful, deceptive, or unfair. Financial advertisers have many additional regulatory requirements such as: the Federal Trade Commission (FTC) and the Securities and Exchange Commission (SEC); industry associations (e.g., Financial Industry Regulatory Authority (FINRA)); and various departments within each individual state (e.g., state banking department, attorney general's office, and insurance office). If a financial services firm runs afoul of compliance with these regulations and laws, there can be fines, substantial penalties and potential lawsuits.

There is a wide range of marketing methods and levels of sophistication in marketing financial products. On one end of the marketing continuum is one-to-one selling, or personal relationship selling. On the other end of the marketing continuum is the use of technology to sell, or technology-based selling. Regardless of the marketing methods used, the marketing of financial products requires compliance with the government-imposed regulations.

### BRIEF DESCRIPTION OF DRAWINGS

Some embodiments are illustrated by way of example and not limitation in the figures of the accompanying drawings in which:

FIG. 1A illustrates a multi-tenant publishing system, according to an example embodiment.

FIG. 1B illustrates an example of a multi-tenant environment for financial markets.

FIG. 1C a multi-tenant publishing system in a networked system, according to an example embodiment.

FIG. 1D illustrates a high level block diagram of a multi-tenant publishing system, according to an example embodiment.

FIG. 2A illustrates an individual subscriber of the multi-tenant publishing system, according to an example embodiment.

FIG. 2B illustrates an entity subscriber of the multi-tenant publishing system, according to an example embodiment.

FIGS. 2C-2E illustrate example relationships between individual subscribers and entity subscribers of the multi-tenant publishing system.

FIGS. 3A-3B illustrate an example of a handshake between two entity subscribers.

FIG. 3C-3D illustrate publishing compliant content by subscribers, according to example embodiments.

FIG. 4A illustrates a user profile table, according to an example embodiment.

FIG. 4B illustrates a meta attribute table, according to an example embodiment.

FIG. 4C illustrates a content metadata table, according to an example embodiment.

FIG. 4D illustrates a policy table, according to an example embodiment.

FIG. 4E illustrates a mapping between content metadata, meta attributes associated with users, and company policies, according to an example embodiment.

FIG. 5A illustrates meta attributes associated with a user from multiple companies, according to an example embodiment.

FIG. 5B illustrates meta attributes associated with a user from multiple types of data sources, according to an example embodiment.

FIG. 5C illustrates meta attributes associated with a user from multiple types of data sources, according to another example embodiment.

FIG. 6A illustrates a high level diagram of governance of an individual subscriber by multiple entity subscribers, according to an example embodiment.

FIG. 6B illustrates conflicting attributes associated with an individual subscriber, according to an example embodiment.

FIG. 6C illustrates a high level diagram of governance logic, according to an example embodiment.

FIG. 6D illustrates meta attributes associated with a user having priority level information.

FIG. 7A illustrates a flow diagram of a method for delivering uploaded compliant content in two stages, according to an example embodiment.

FIG. 7B illustrates a flow diagram of a method to provide access to uploaded compliant content using segmentation, according to an example embodiment.

FIG. 7C illustrates a flow diagram of a method to manage engagement activity related to uploaded compliant content based on governing corporate policies, according to an example embodiment.

FIG. 7D illustrates another example of a flow diagram of a method to for delivering uploaded compliant content, according to an example embodiment.

FIG. 8 is a block diagram of machine in the example form of a computer system within which a set of instructions may be executed for causing the machine to perform any one or more of the methodologies herein discussed.

The headings provided herein are merely for convenience and do not necessarily affect the scope or meaning of the terms used.

### TECHNICAL FIELD

Embodiments of the present disclosure relate generally to publishing systems, and more particularly, but not by way of limitation, to the multi-tenant publication systems for financial content.

### DETAILED DESCRIPTION

The description that follows includes systems, methods, techniques, instruction sequences, and computing machine program products that embody illustrative embodiments of the disclosure. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail.

Multi-tenant publishing methods and systems for the financial industry are described. The multi-tenant publishing methods and systems provide a scalable and/or measurable way to acquire, publish, distribute and share online compliant financial marketing content, primarily by financial advisors, product manufacturers, product providers and other financial professionals. Financial advisors, also referred to as advisors, may use the financial marketing content as a tool for client engagement activity in the marketplace.

Example embodiments provide systems and methods for publishing financial content. The multi-tenant publishing system may apply two stages to manage the publication of uploaded compliant content. The first stage may be referred to as the scope-defining stage, and the second stage may be referred to as the policy stage. During the first stage, the content providers have control over the delivery of the uploaded compliant content based on segmentation using metadata. The content providers use segmentation to generate a segment representing a filtered group of users to have access to the uploaded compliant content. The segmentation is based on meta attributes available to the content provider. During the second stage, the companies that manage, from a corporate perspective, the individuals from the filtered group of users (also referred to as publishers) control what actions the individuals take with respect to the delivery of the uploaded compliant content. Governance refers to the oversight of activity instituted by one or more organization's (e.g., entity subscriber) policies on the user (e.g., individual subscriber). These policies are typically a function of interpreted SEC and/or FINRA and state rules and laws (related to compliance) and can also be based on policies of a corporation or other entity (e.g., entity subscriber). Collectively, these policies are referred to as “corporate polices”). The individuals from the filtered group of users are obligated to adhere to the corporate policies of companies that manage them. An individual from the filtered group of users may have multiple companies governing their actions related to the delivery (or re-sharing) of the uploaded compliant content. In some situations, there may be a conflict between the companies that govern their actions related to the delivery of the uploaded compliant content. As such, authorization to access, share, or re-share uploaded compliant content is managed by both the content provider and the companies in a multi-tenant environment.

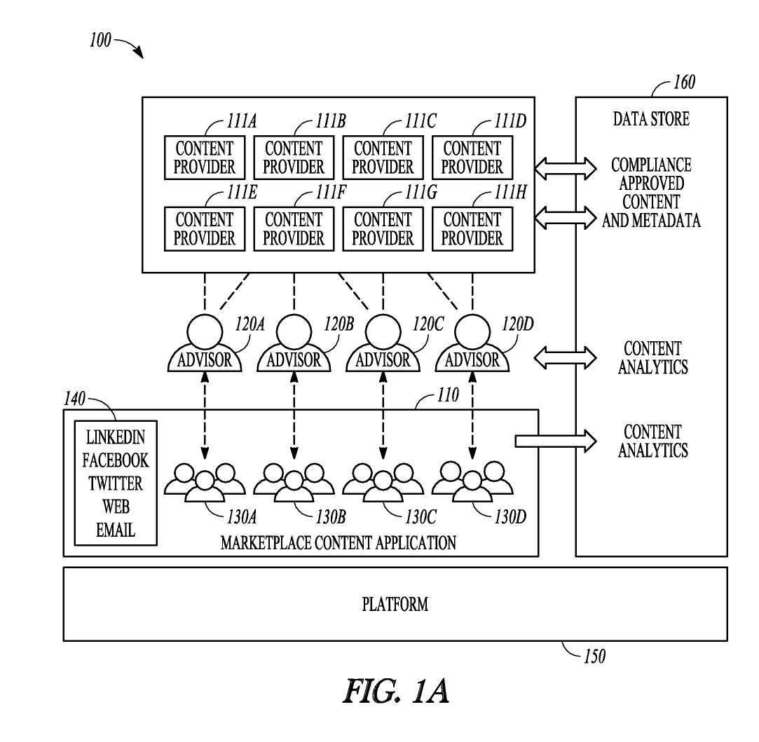

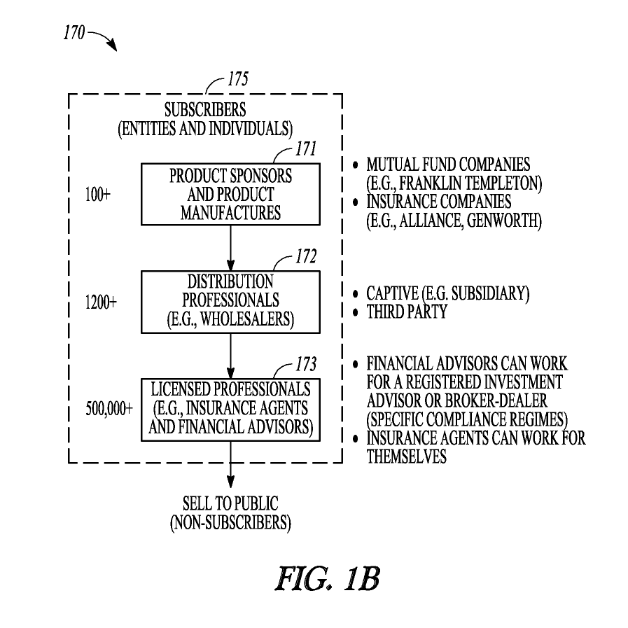

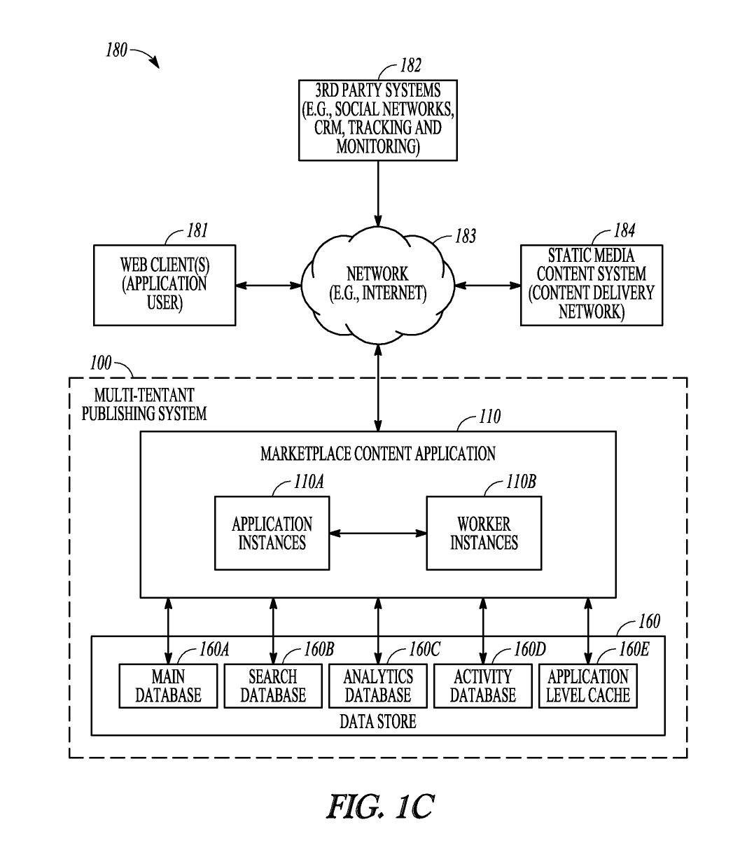

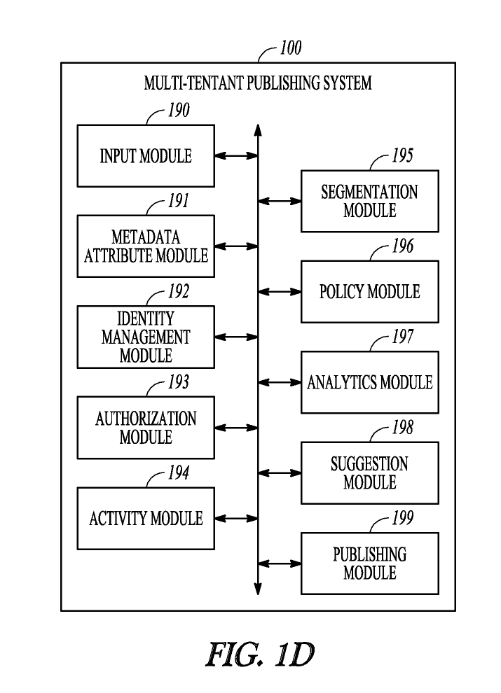

A multi-tenant publishing system 100 for the financial industry is described in FIG. 1A according to example embodiments. In various embodiments, the multi-tenant publishing system 100 publishes content that has been designated to be compliant, and is referred to as compliant content. The compliant content may represent “compliance approved” electronic documents, media content (e.g., videos or images), or any other type of content that can be distributed online. In example embodiments, the compliant electronic documents may represent various financial marketing collateral such as brochures, advertisements, data sheets and other documents for marketing financial products and services.

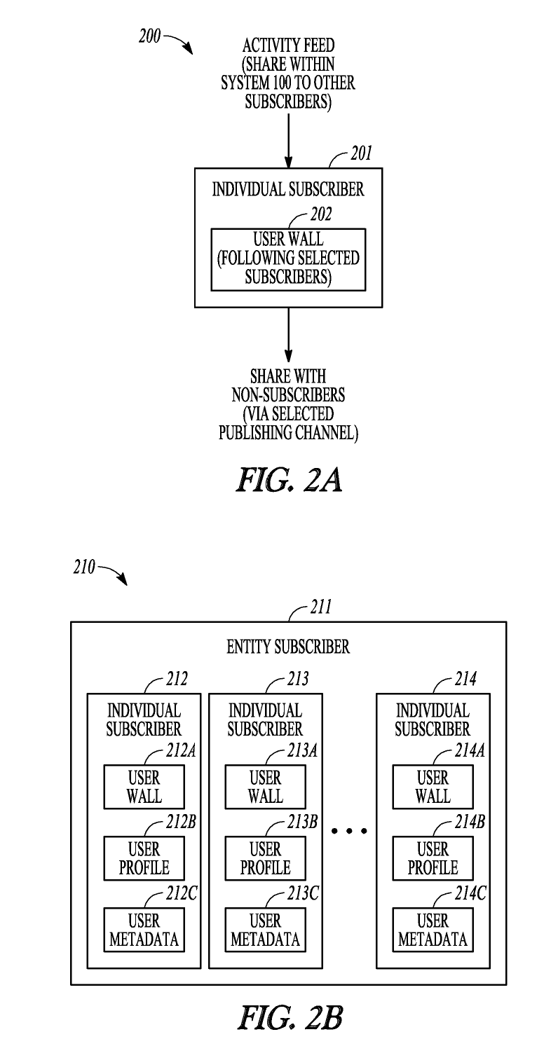

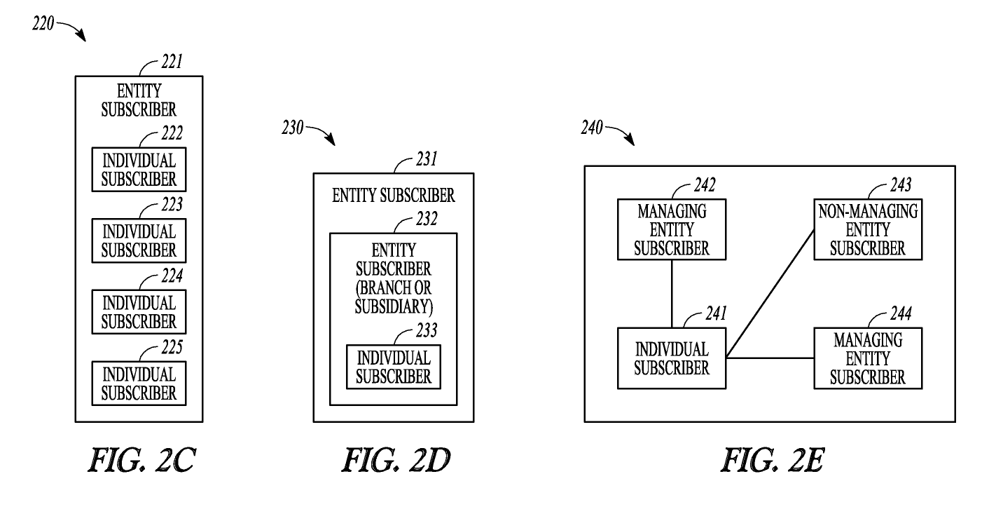

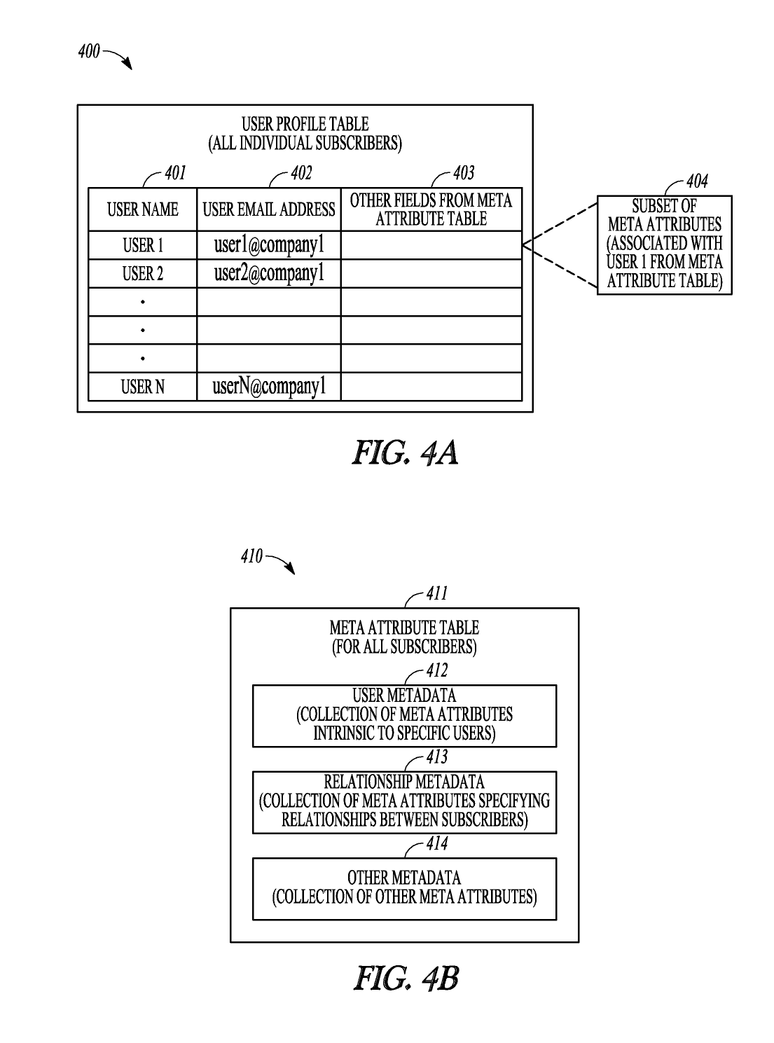

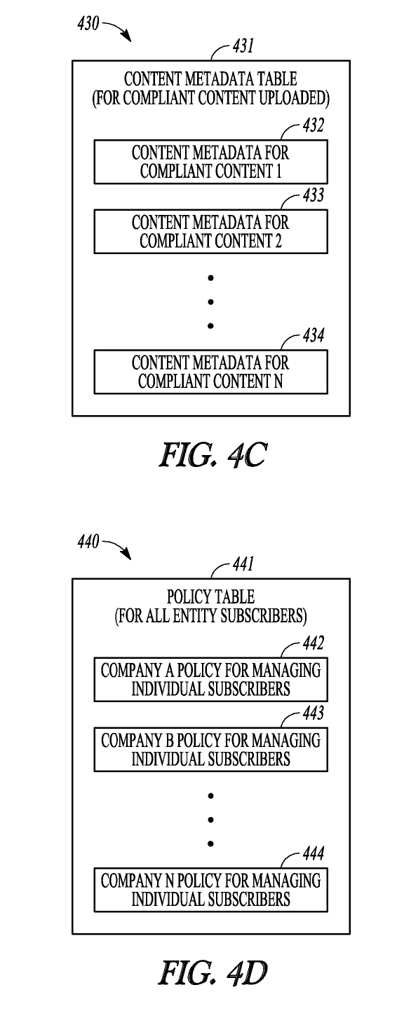

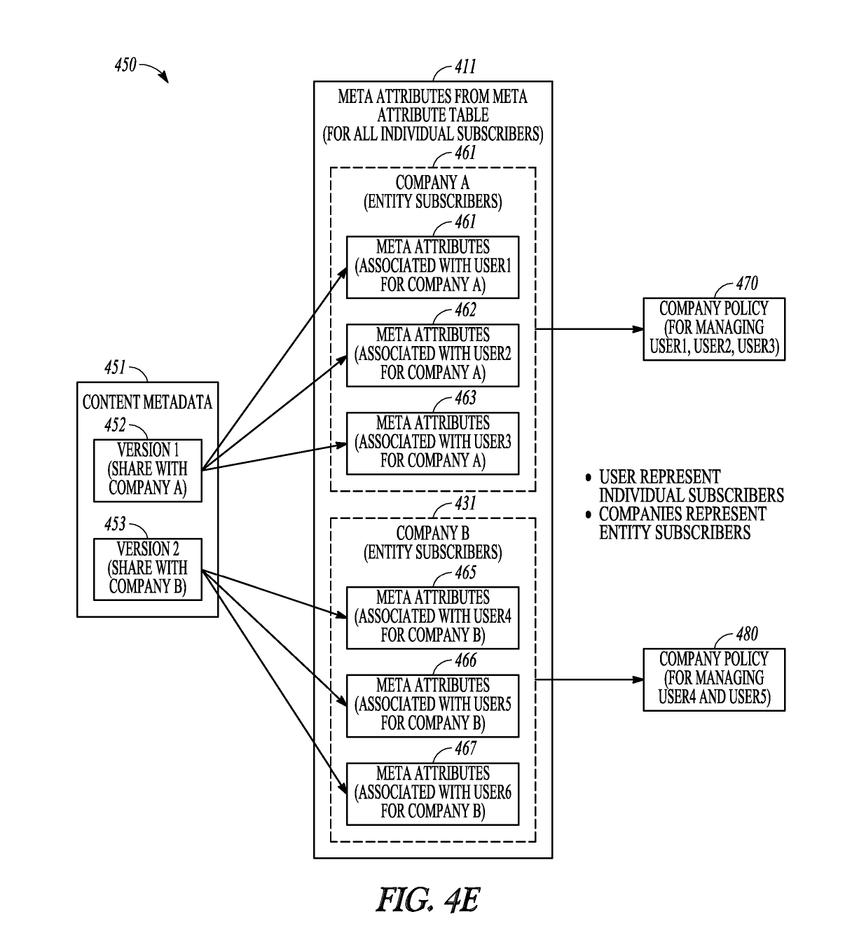

The multi-tenant publishing system 100 may have many subscribers representing a multi-tenant environment for a financial marketplace. An example of a multi-tenant environment is shown in FIG. 1B. In example embodiments, the subscribers 175 include entity subscribers (e.g., corporations, firms, organizations or other entities) or individual subscribers. The individual subscribers 175 may be associated with one or more entity subscribers. Generally, the entity subscribers manage many individual subscribers who are governed by the corporate policies of the entity subscribers. FIGS. 2C-2E illustrate some example relationships between individual subscribers and entity subscribers. The individual subscribers each have a user profile stored in a user profile table shown in FIG. 4A.

The user profile table 400 shown in FIG. 4A includes a user name field 401, a user email address field 402, and other fields 403 from the meta attribute table 411. The other fields (for user 1) may include a subset of meta attributes 404 associated with user 1 from the meta attribute table 411. The meta attributes associated with user 1 may be user metadata, relationship metadata, or other metadata. Some of the meta attributes associated with user 1 may be stored in the user profile table 400, or stored in the meta attribute table 411 and associated with (or related in some way to) the user profile of user 1. The user profile of an individual subscriber allows the multi-tenant publishing system 100 to identify the individual subscribers as authenticated users of the system 100 and allows subscribers to log into the system 100. The subscribers include both paying subscribers and non-paying subscribers. Individuals who do not have an associated user profile in the multi-tenant publishing system 100 may be considered a non-subscriber. Depending on the specified delivery criteria (provided by the content provider) of uploaded compliant content, subscribers and non-subscribers may be recipients of the uploaded compliant content.

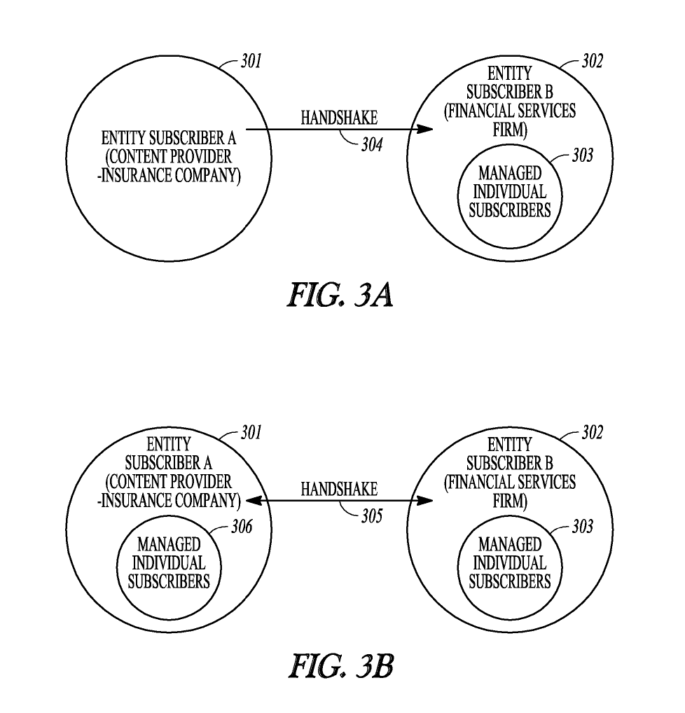

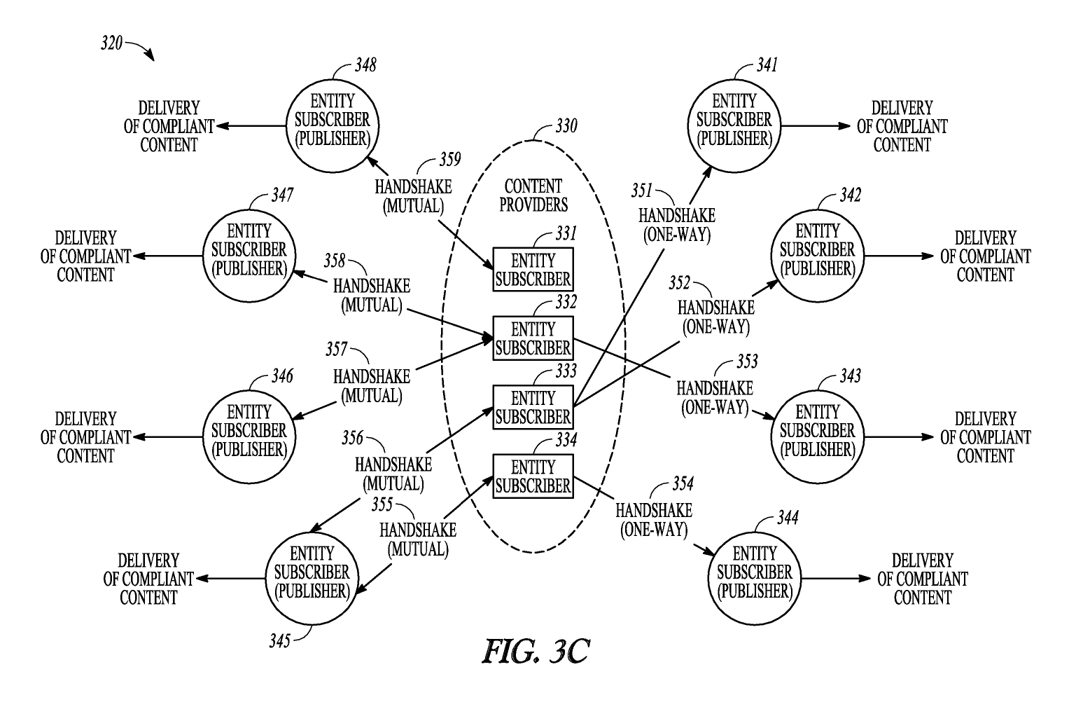

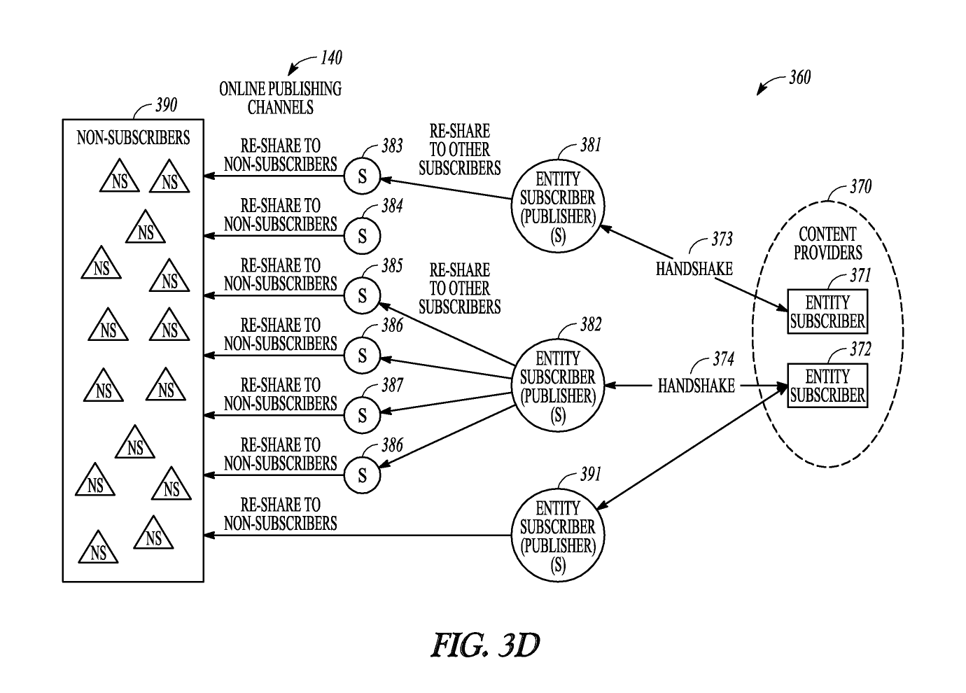

The delivery of uploaded compliant content is referred to as publishing, distributing, sharing or re-sharing throughout the specification to describe the various embodiments. Newly uploaded compliant content is shared with other subscribers, or made available to other subscribers by other means. As shown in FIG. 2A, an individual subscriber 201 has a dashboard referred to as a user wall 202 in diagram 200. The newly uploaded compliant content may be shared with the individual subscriber 201 via the user wall 202. The uploaded compliant content may be made available to the individual subscriber 201 by other means such as searching within the multi-tenant publishing system 100 to access the newly uploaded compliant content. The individual subscribers 201 who has access to the newly uploaded compliant content may then re-share (i.e., publish, deliver, distribute, etc.) the uploaded compliant content with others in accordance with the corporate policies governing them. FIGS. 3C and 3D illustrate examples of the delivery of uploaded compliant content.

The subscribers who upload compliant content may be referred to as content providers or content publishers. The content providers share with (or make the uploaded compliant content available to) a filtered group of individual subscribers.

The subscribers who re-share the uploaded compliant content with others (either subscribers or non-subscribers) may be referred to as publishers. A single subscriber may be both a content provider and a publisher. The publishers or the recipients of the uploaded compliant content from the publishers may be referred to as content consumers.

Referring back to FIG. 1A, the content providers 111a -111h upload compliant content to the multi-tenant publishing system 100. Examples of content providers 111a -111h include mutual fund companies, insurance companies, and other financial and product providers. A marketplace content application 110 is used as a sales and marketing channel for the content providers 111a-111h and other subscribers.

During the process of uploading compliant content by the content providers 111a-111h, the content providers 111a-111h provide content metadata (or other information) to generate a segment of individual subscribers who are the target audience of the uploaded compliant content. This filtered group of individual subscribers is provided access to the uploaded compliant content.

The meta attributes available for use by the content providers 111a-111h are a subset of the meta attributes included within a meta attribute table of the multi-tenant publishing system 100. The uploaded compliant content has associated content metadata provided by the content providers 111a-111h which is used to target the delivery of the uploaded compliant content to individual subscribers filtered by the content providers 111a-111h. Once the uploaded compliant content becomes available (or accessible) to an individual subscriber from the group of filtered individual subscribers, that individual subscriber may re-share the uploaded compliant content in accordance with any of its governing corporate policies.

The advisors 120a-120d and the user groups 130a-130d represent the data consumers in the example shown in FIG. 1A. In the example shown in FIG. 1A, one or more of the advisors 120a-120d may represent a target audience to have access to the uploaded compliant content. The uploaded compliant content may be made available to the advisors 120a-120d through one or more publishing channels 140, for example, email websites, social networks, and postings on a subscriber's user wall.

The written supervisory procedures (“WSP”) for broker-dealers address the requirements of supervisory rules, which require firms to establish and maintain a system to supervise the activities of registered representatives, management, and associated staff. The multi-tenant publishing system 100 is designed to achieve compliance with applicable laws and regulations. Every broker-dealer has an obligation to supervise the activities of its registered and associated persons including advisors 120a-120d. These policies are designed to assist firms (e.g., entity subscribers) and designated personnel (e.g., individual subscribers) in ensuring compliance with the rules and regulations of the U.S. Securities and Exchange Commission (“SEC”), FINRA, and the applicable state jurisdiction(s) in which the firm and its registered representatives are conducting business.

For various embodiments, the compliant content published by the content providers undergoes a compliance review process (prior to upload to the multi-tenant publishing system 100). In example embodiments, the uploaded compliant content adheres to the relevant written supervisory procedures of a broker-dealer, before being accessible on the multi-tenant publishing system 100 to the advisors 120a-120d. The uploaded compliant content may include advertising compliance reviews performed by broker-dealers prior to being published by a content provider in example embodiments.

The segment of individual subscribers (also referred to as the group of filtered individual subscribers) who have access to the uploaded compliant content may engage in further activity related to the uploaded compliant content. The individual subscribers from the group of filtered individual subscribers are obligated to adhere to the corporate policies of any entity subscribers governing their actions related to the uploaded compliant content. In accordance with any governing corporate policies, the advisors 120a-120d may engage with one or more of the user groups 130a-130d. The financial advisors 120a-120d and/or the people in the user groups 130a-130d represent independent financial professionals, product manufacturers, product providers, broker-dealers, customers, etc. in various embodiments.

The marketplace content application 110 includes a user interface which provides several online publishing channels 140 such as websites, blogs, telephony, social networks, email and postcards to distribute and share financial marketing content. Through the various online publishing channels 140, links to the published material are shared, and may be subsequently re-shared with customers, potential customers and other third parties. Because the financial industry is a highly regulated industry, the subscribers publish compliance “approved” materials to customers, potential customers and other third parties.

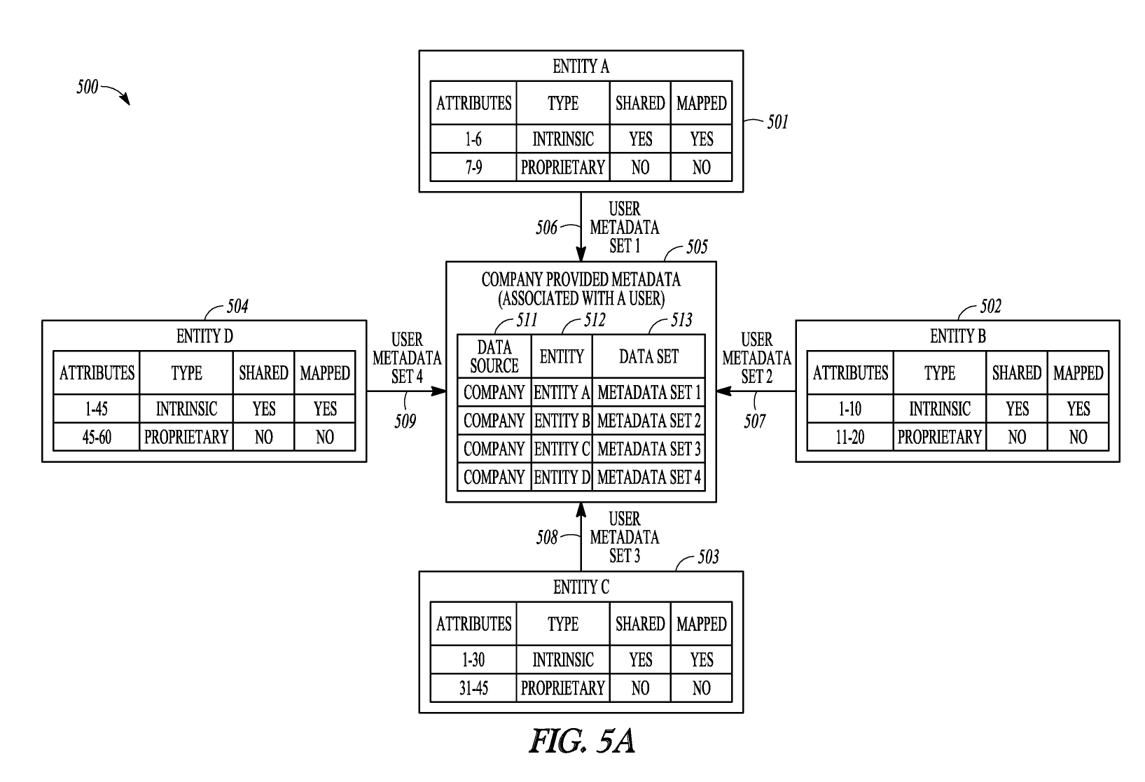

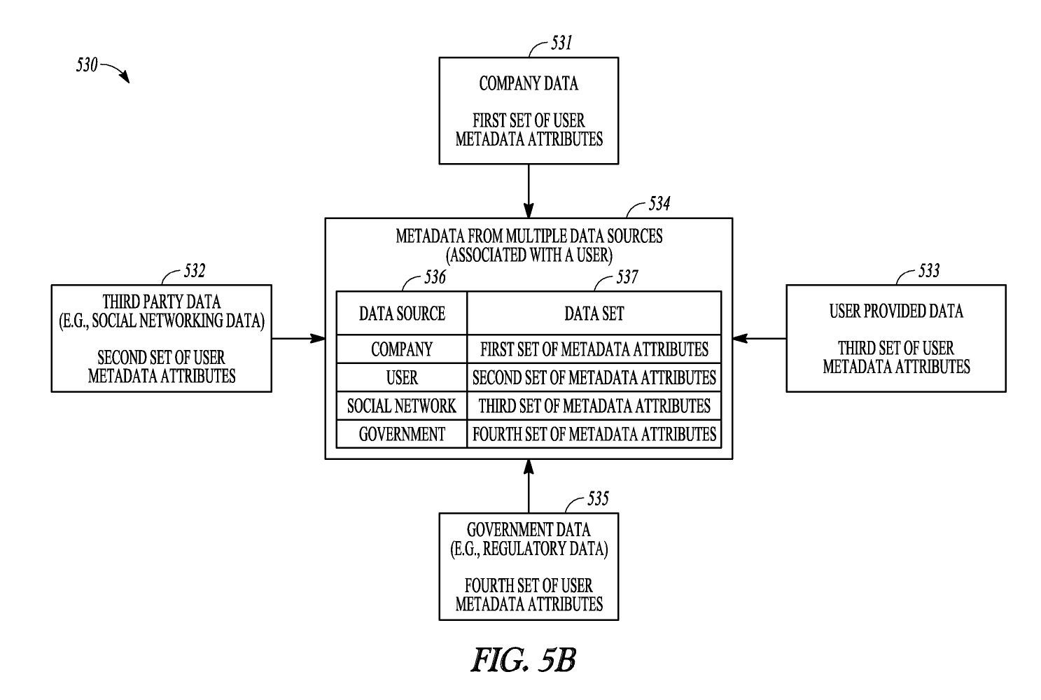

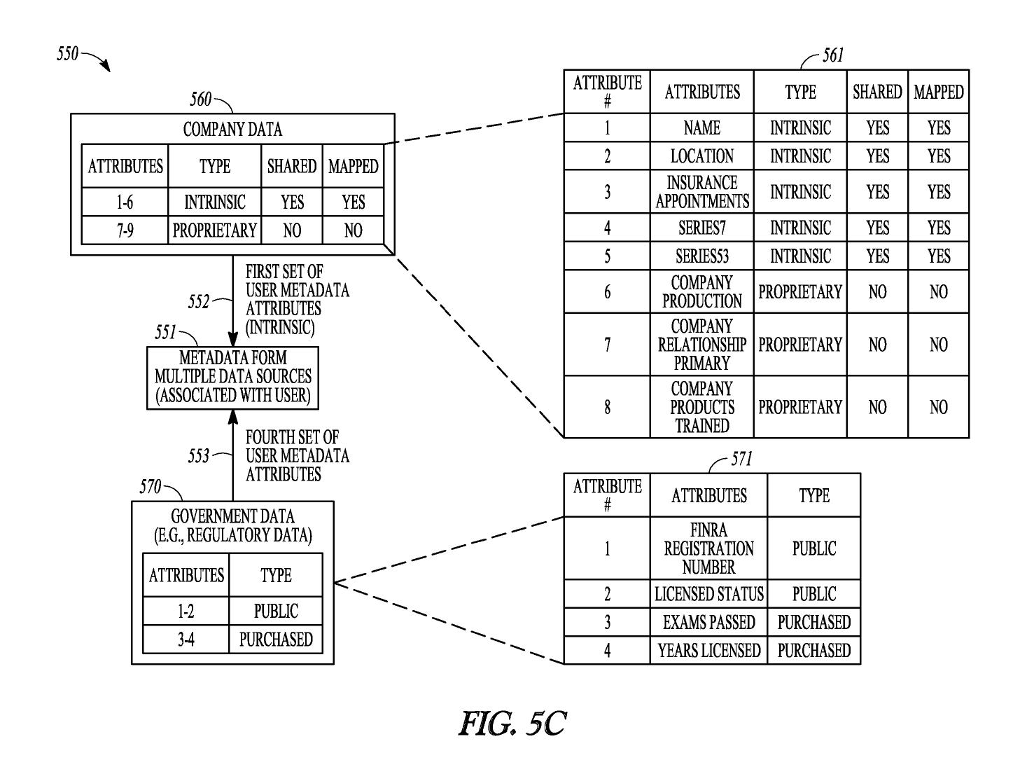

For various embodiments, one or more components of the multi-tenant publishing system 100 may reside in a cloud computing environment (not shown). The multi-tenant publishing system 100 includes a platform 150 and data store 160, which may both reside within the cloud computing environment in an example embodiment. In some embodiments, the marketplace content application 110 may reside in the cloud computing environment. The content providers 111a-111h may upload the compliant content using a client device (not shown) to the marketplace content application 110. The marketplace content application 110 resides on top of a platform 150 in an example embodiment. The data store 160 stores compliance-approved content and metadata, content analytics data, and the engagement activity data in various embodiments. The data store 160 receives data from the marketplace content application 110, the advisors 120a-120d, and all other subscribers of the marketplace content application 110, including information about customers or others who receive published material which links are shared and re-shared through one of the online publishing channels 140 available in the marketplace content application 110. The marketplace content application 110 generates and outputs business intelligence using its content analytics data. The data store 160 also receives data from multiple sources to create the meta attribute table 411. For example FIGS. 5A-5C illustrate examples of third party sources that provide metadata to the data store 160.

The multi-tenant publishing system 100 offers “last mile client intelligence” in various embodiments using the data accessed from the data store 160. The “last mile” refers to the challenges associated with completing the last mile in a marathon. In the context of publishing financial content and marketing, “last mile client intelligence” refers to the challenges of efficiently connecting clients, potential clients or other third parties with product manufacturers or other members of the financial value chain. For one example, a product manufacturer shares feeds into the data store 160 on how its products are doing in the marketplace. The data store 160 also receives client intelligence from downstream feeds when a subscriber, such as an advisor, shares content with the clients, potential clients, or other third parties, which may be re-shared with other third parties. By receiving data from both the upstream and downstream feeds, valuable business intelligence can be gathered to address the specific client situation. A broad set of pre-built data analytics models and algorithms enables an advisor, and other subscribers in the value chain, to pave the last mile for their clients. Using business intelligence, the multi-tenant publishing system 100 may be used to highlight opportunities to increase value from the customer relationship, for example, by generating more frequent sales to the client or selling a variety of different products.

FIG. 1B illustrates an example of a multi-tenant environment for a financial market 170 according to an example embodiment. The multi-tenant environment for a financial market 170 includes a large number of subscribers 175, which may be individual subscribers or entity subscribers. Associated with each entity subscriber are multiple individual subscribers as shown in FIG. 2B. FIG. 2B illustrates a diagram 210 representing an entity subscriber 211 with associated individual subscribers 212-214. Each of the subscribers 212-214 is associated with a user wall (e.g., 212a, 213a, and 214a), a user profile (212b, 213b, and 214b), and user metadata (e.g., 212c, 213c, and 214c). As mentioned above, an entity subscriber may be a managing entity subscriber of an individual subscriber. Examples of relationships between individual subscribers and entity subscribers are described below along with FIGS. 2C-2E.

In the example shown in FIG. 1B, the subscribers 175 may be categorized into three groups. The first group includes product sponsors and product manufacturers 171, the second group includes distribution professionals 172 (e.g., wholesalers) and the third group includes licensed professionals 173 (e.g., insurance agents and financial advisors). The numbers to the left of the three groups represent possible tenants in the multi-tenant environment for a financial market 170 from each of the groups. In an example embodiment, there are over 100 product sponsors and product manufacturers 171, over 1200 distribution professionals 172, and over 500,000 licensed professionals 173.

Examples of product sponsors and product manufacturers 171 are mutual fund companies (e.g., Franklin Templeton) and insurance companies (e.g., Allianz and Genworth Financial). In various embodiments, the product sponsors and product manufacturers 171 may generate and create content for upload into the multi-tenant publishing system 100. As such, the product sponsors and product manufacturers 171 may be content providers, in addition to content consumers. The distribution professionals 172 and licensed professional 173 are examples of content consumers.

In one example, one of the product sponsors and product manufacturers 171, referred to as company A, creates a video which is compliant with the compliance policies of Company B (which may represent a broker dealer). The company A is also the content provider and uploads the compliant video to the multi-tenant publishing system 100. Company A, the content provider, may use various meta attributes available to him or her to target the delivery of the uploaded compliant video to only licensed professionals managed by Company B. The Company B may represent the content consumer.

In example embodiments, the distribution professionals 172 and the licensed professionals 173 are downstream from the product sponsors and product manufacturers 171. The distribution professionals 172 and the licensed professionals 173 may be referred to as content consumers. The distribution professionals 172 may be associated with the product sponsors and product manufacturers 171 as either a captive (e.g., subsidiary) or an independent third party in some embodiments. The licensed professionals 173 generally sell financial services and products to the public. Individuals who are not subscribers of the multi-tenant publishing system 100 may be referred to as non-subscribers. The licensed professionals 173 who are insurance agents may not have an umbrella organization and may work for themselves. The licensed professionals 173 who are financial advisors may work for a registered investment advisor or broker-dealer. The broker-dealers have specific compliance regimes they implement which comply with government rules and regulations.

In some embodiments, the multi-tenant publishing system 100 may operate as a publishing clearing house that collects and distributes financial content, such as marketing and sales collateral. The content providers, such as the product sponsors and product manufacturers 171, may upload compliant financial content which gets distributed (e.g., shared and re-shared among subscribers and non-subscribers) by subscribers (e.g., distribution professionals 172 and licensed professionals 173) of the multi-tenant publishing system 100, who are governed by the relevant metadata and corporate policies. By simplifying the distribution of compliant content among multiple tenants in an approved manner consistent with any governing corporate policies, it is possible for the product sponsors and product manufacturers 171 to distribute co-branded advertising and marketing financial content with their distribution professionals 172 and licensed professionals 173.

The multi-tenant publishing system 100 simplifies distribution of approved compliant content by making such content available to subscribers in a sharable format, such that they know what content is sharable and with whom it is sharable and may share and re-share the approved compliant content among multiple channels by a simple click of a button. Various types of metadata may be used to target delivery of the uploaded compliant content in a manner approved by the entity subscribers. The entity subscribers may approve the distribution of compliant content on an organizational level using the handshake feature (shown in FIGS. 3A-3B and described below) of the multi-tenant publishing system 100. The entity subscribers also have corporate policies that govern the actions of the individual subscribers that they manage related to the delivery of uploaded compliant content. For example, a corporate policy may specify who to share or re-share the uploaded compliant content with and by what delivery channels.

FIG. 1C a multi-tenant publishing system 100 in a networked system 180, according to an example embodiment. The networked system 180 includes a network 183 (e.g., the Internet or Wide Area Network (WAN)) to one or more clients (e.g., a web client 181). The web client 181, in one example, may be a browser, such as the Internet Explorer browser developed by Microsoft Corporation of Redmond, Washington State). In other embodiments, a programmatic client (not shown) executing on a client machine (not shown) may also be used.

The multi-tenant publishing system 100 includes a marketplace content application 110 in communication with the data store 160 which includes data storage devices 160a-160e. The marketplace content application 110 includes application instances 110a and worker instances 110b. The marketplace content application 110 may receive data from third party systems 182, such as social networks, customer relationship management (CRM), and tracking and monitoring systems. In some embodiments, the multi-tenant publishing system 100 (or a portion of the multi-tenant publishing system 100) may be integrated with one or more third party system 182. The marketplace content application 110 provides lightweight data validation and processing and exposes a RESTful Web API in some embodiments. The worker instances 110b, which may be referred to as the data crunching layer, performs asynchronous processing tasks and periodic and scheduled jobs in some embodiments.

For various embodiments, the marketplace content application 110 is integrated with various CRMs. In various embodiments, the integrated CRMs allow address books from the user segment of the CRMs to be imported into the marketplace content application 110 and any leads or conversations may feed back into the CRMs according to an example embodiment. For example, if a certain piece of content performs well, the marketplace content application 110 sends a notification back to the CRM. This marketing business intelligence is sent from the marketplace content application 110 back to the CRMs for local storage and retrieval in context. In one example, if a tweet is responded to, the conversation thread is stored. For example embodiments, the marketplace content application 110 (which may represent a social layer in a CRM) may generate and present social engagement information to the subscribers of the CRM in their social information pane. For other embodiments, the marketplace content application 110 may generate and present, at the broker-dealer level, which accounts have the most engagements and which accounts are not performing as well, etc.

The marketplace content application 110 may be hosted by an application server residing within a cloud environment in an example embodiment. For various embodiments, the platform 150 (shown in FIG. 1) may be hosted by application server(s) residing within the cloud environment. The application servers hosting the marketplace content application 110 are coupled to one or more database servers (not shown) that facilitate access to the data store 160, which includes storage devices 160a-160d. In example embodiments, the meta attribute tables 411, the content metadata table 431, the policy table 441, and the user profile table 401 may be stored in the main data store 160. In one embodiment, the analytics database 160c may be implemented using MongoDB, which is an open-source NoSQL database. In example embodiments, the activity database 160d may be implemented using Cassandra, which was developed by the Apache Software Foundation. Cassandra is an open source distributed database management system designed to handle large amounts of data across many commodity servers. In one embodiment, the functionality of the multi-tenant publishing system 100 related to the activity feeds (e.g., indexing and building feeds that are visible to individual subscribers) and the governance logic are implemented using Cassandra.

Also coupled to the network 183 is the static media content system 184, which provides a content delivery network. Various types of static information or documents may be retrieved or accessed by the multi-tenant publishing system 100 or its subscribers and delivered or accessed via the static media content system 184. The static media content system 184 may store the uploaded compliant content in the cloud computing environment.

The marketplace content application 110 may provide a number of marketplace functions and services to subscribers that access the multi-tenant publishing system 100. The marketplace content application 110 may be implemented as standalone software programs, which do not necessarily have networking capabilities. Alternative embodiments may be implemented in a cloud computing environment, where software is provided as a service to the end users of the web clients 181.

FIG. 1D illustrates a block diagram showing modules 190-199 (also referred to as components) provided within the multi-tenant publishing system 100 according to some embodiments. The multi-tenant publishing system 100 may be hosted on dedicated or shared server machines (not shown) that are communicatively coupled to enable communications between server machines. The modules 190-199 themselves may be communicatively coupled (e.g., via appropriate interfaces) to each other and to various data sources, so as to allow information to be passed between the applications or so as to allow the applications to share and access common data. Furthermore, the modules 190-199 may access one or more storage devices 160a-160e. All, or a portion, of the modules 190-199 may communicate with each other, for example, via a network coupling, shared memory, and the like. It will be appreciated that each module 190-199 may be implemented as a single module, combined into other modules, or further subdivided into multiple modules. Other modules not pertinent to example embodiments may also be included, but are not shown.

In various embodiments, the multi-tenant publishing system 100 includes one or more of the following modules: an input module 190, a meta attribute module 191, an identity management module 192, an authorization module 193, an activity module 194, a segmentation module 195, a policy module 196, an analytics module 197, a suggestion module 198, and a publishing module 199.

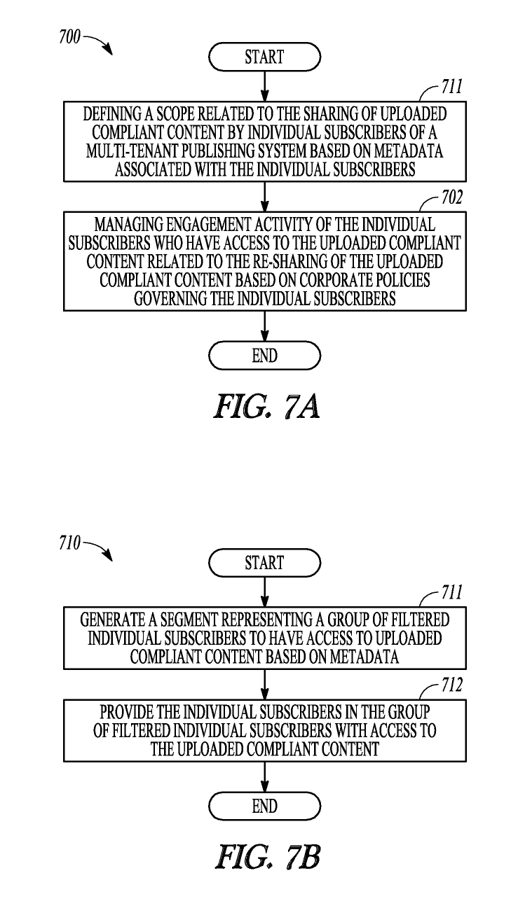

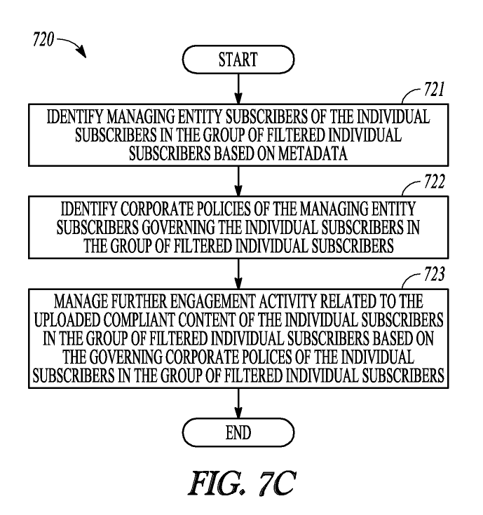

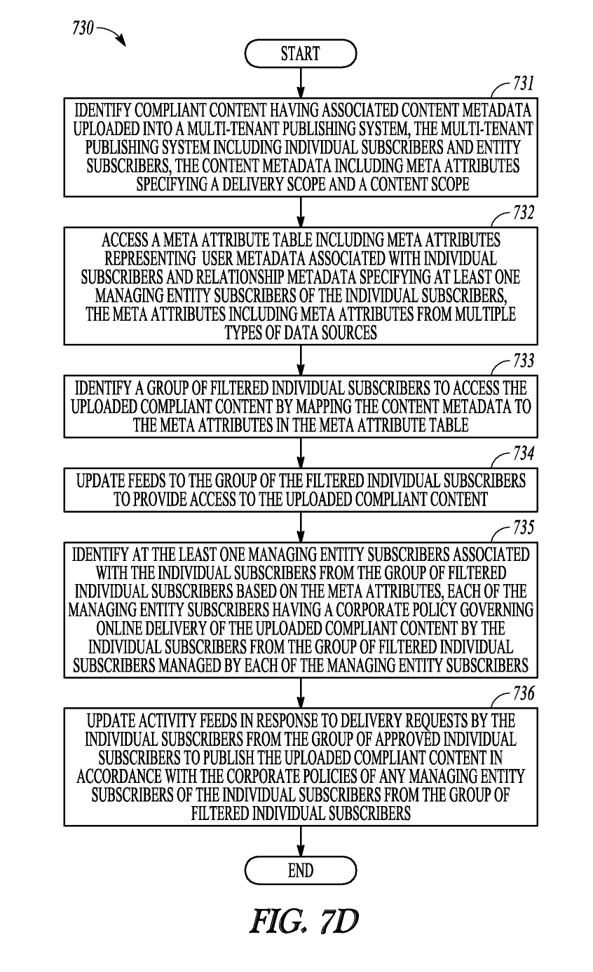

In example embodiments, at least some of the modules 191-199 may be combined, partially or fully, to implement a scope defining stage module (note shown) representing the functions of the scope defining stage, and a policy stage module (not shown) representing the functions of the policy stage. In various embodiments, the multi-tenant publishing system 100 may implement two stages to manage the publication of uploaded compliant content—the scope defining stage and the policy stage. FIG. 7A illustrates the operations of the two stages, according to an example embodiment.

During the scope defining stage, the scope defining stage module enables the content providers to manage the delivery of the uploaded compliant content based on segmentation using metadata. The content providers use segmentation to generate a segment representing a filtered group of users to have access to the uploaded compliant content. The segmentation is based on meta attributes available to the content provider. The attributes available to the content provider are a subset of attributes stored in the meta attribute table 411. Based on the attributes available to the content provider, or information inferred from those attributes, the content provider defines specific criteria, referred to as the content metadata associated with a particular compliant content, which is uploaded into the multi-tenant publishing system 100. The meta attribute module 191 (alone or in combination with the identity management module 192) provides meta attribute information to the segmentation module 195 to perform the segmentation. The content metadata is used to generate a segment (by the segmentation module 195) to define a group of filtered individual subscribers who have access to the uploaded compliant content.

FIG. 4C illustrates a diagram 430 of a content metadata table 431 storing content metadata for a number (N) of different pieces of compliant contents. The content metadata from compliant content 1 432, the content metadata for compliant content 2 433 and the content metadata for compliant content N 434 are shown in the content metadata table 431. The content metadata table 431 may be represented as a separate table from the meta attribute table 411, or included as part of the meta attribute table 41.

The meta attributes available to the content provider may be presented as fields in a user interface for the content provider to input data. The input data provided by the content provider may represent the content metadata associated with the particular compliant content the content provider is uploading. In various embodiments, the content metadata is received by the input module 190 and processed by the metadata attribute module 191 together with the identity management module 192 and the segmentation module 195, to identify the group of filtered individual subscribers who are designated to have access to the uploaded compliant content. In some embodiments, the authorization module 193 authorizes access to the individual subscribers from the group of filtered individual scribers. The activity module 194 shares uploaded compliant content or makes the uploaded compliant content available to the individual subscribers from the group of filtered individual subscribers. The various operations implemented by the scope defining stage module are described in FIG. 7B, according to an example embodiment.

During the policy stage, the policy module 196 enables the entity subscribers (that manage, from a corporate perspective, the individuals from the filtered group of individual subscribers) to manage further engagement activity related to the delivery of the uploaded compliant content by those individual subscribers. The entity subscriber provides input, such as policy data, into the multi-tenant publishing system 100 to administer and manage their corporate policies. Policy data is received by the input module 190. In various embodiments, the policy data is stored as attributes in the metadata attribute table 411 typically as relationship metadata or other metadata. In some embodiments, the identity management module 192, based on relationship metadata provided by the metadata attribute module 191, identifies the managing entity subscribers associated with the individual subscribers from the group of filtered individual subscribers. The individual subscribers from the group of filtered individual subscribers are obligated to adhere to the corporate policies of their managing entity subscribers. In some embodiments, the policy module 196 receives relationship information from the identity management module 192 to identify the governing corporate policies associated with the individual subscribers (from the group of filtered individual subscribers). The policy module 196 filters further engagement activity (related to the delivery of uploaded compliant content) of the individual subscribers based on the governing corporate policies of the individual subscribers (from the group of filtered individual subscribers). Based on information provided by the identity management module 192, further engagement activity of the individual subscribers (from the group of filtered individual subscribers) is authorized by the authorization module 193 in various embodiments. The publishing module 199 and the activity module 194 are used to deliver, for the individual subscribers (from the group of filtered individual subscribers), the uploaded compliant content in accordance with their governing corporate polices in example embodiments.

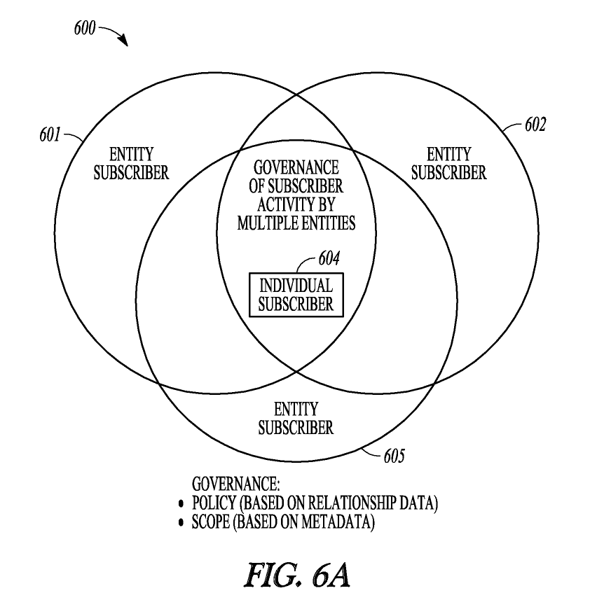

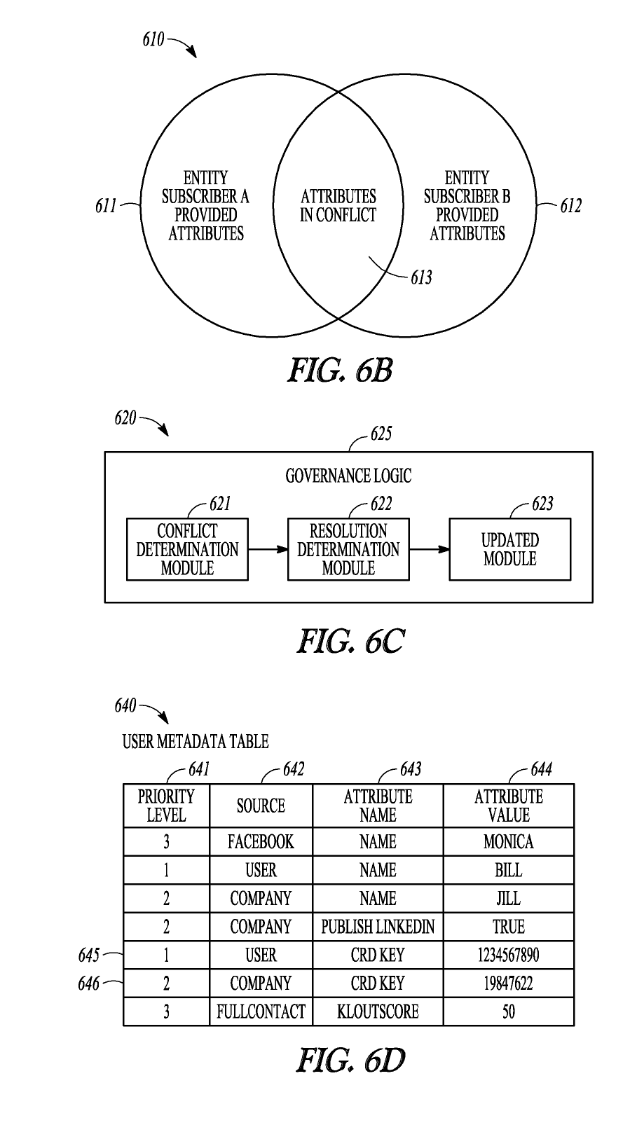

An individual subscriber (from the filtered group of individual subscribers) may have multiple entity subscribers governing their actions related to the delivery (or re-sharing) of the uploaded compliant content. In some situations, the governance logic 625 (shown in FIG. 6C) may be used to resolve the conflict. In example embodiments, the governance logic 625 may be implemented in the metadata attribute module 191. The governance logic 625 may rely on the suggestion module 198 to acquire additional information from an individual subscriber to resolve a conflict between conflicting corporate policies governing the individual subscriber. The various operations implemented by the policy stage module are described in FIG. 7C, according to an example embodiment.

As such, authorization to access, share, or re-share uploaded compliant content is managed by both the content provider and the companies in a multi-tenant environment by the scope defining stage module and the policy stage module. FIG. 4E illustrates an example of the scope defining stage performed by the scope defining stage module and the policy stage performed by the policy stage module. The modules 190-199 are described in further detail below.

In various embodiments, the input module 190 receives data from multiple sources where it may be further processed by one or more of the other modules 191-199 and stored in one or more of storage devices 160a-160e. In various embodiments, input module 190 may comprise a search engine (not shown) for conducting searches within the marketplace content application 110. For example, input module 190 may be configured to utilize one or more APIs to access data from the data store 160 or other sources.

The input module 190 is configured to determine the selection of one or more user interface elements by a user and initiate the action associated with the selected user interface element. Examples of three screens that may present content to an individual subscriber include a dashboard view, an engage view, and a share view. The dashboard view may display various feeds regarding published and shared content and associated comments. The engage view may present various subscriber metrics, which can be updated dynamically, according to an example embodiment. The share view may present fields to allow the individual subscriber to filter or specify the target subscribers and to specify the delivery channel to be used. The input module 190 may pass the selections from any of these three screens, as well as other screens, to one or more other modules for further processing.

Other examples are described below. For example, the marketplace content application 110 may present multiple user interfaces to a user in which subscriber-specified data may be provided to the marketplace content application 110. For example, the dashboard (or user walls) provides an interface for subscribers to view uploaded compliant content made available to the individual subscribers. A button or other interface elements may be presented to the individual subscribers on their dashboard to allow them to share uploaded compliant content in accordance with any relevant corporate policies governing them. There may also be an interface element for the selection of the delivery channel to be used to share the uploaded compliant content. In this example, the marketplace content application 110 receives a request to share compliant content via one of the published channels. A user interface may be presented to a content provider to enable the upload of compliant content and selection of content metadata. The marketplace content application 110 receives notification that new compliant content has been uploaded into the marketplace content application 110 and content metadata information associated with the uploaded compliant content. In further examples, the marketplace content application 110 may receive metadata associated with individual subscribers from multiple sources and types of sources. FIGS. 5A-5C illustrate examples of metadata received from third party sources. In additional examples, the marketplace content application 110 may receive input from system administrators of the entity subscribers related to corporate policies, including handshake requests and responses.

These user interfaces may enable users to input data directly into storage devices 160a-e, instruct the marketplace content application 110 to retrieve data from one or more of the modules 190-199, and instruct the multi-tenant publishing system 100 to perform various operations (e.g., analytics) on the data in storage devices 160a-e.

The analytics module 197 is configured to provide recommendations to the advisors (or other subscribers) to deploy recommended relevant material in a scalable manner. The analytics module 197 may measure content effectiveness and client engagement accurately. The recommendations for relevant uploaded compliant content may be presented in the subscriber's feed and may be fully automated. The analytics module 197 may rely on meta attributes associated with individual subscribers to recommend relevant compliant content personalized for their business.

The analytics module 197 is configured to generate various subscriber metrics which may be dynamically presented to the subscriber in his or her dashboard according to various embodiments. For example, the subscriber metrics may include one or more graphs, charts and values for the following metrics: Networks, Views, Engagement, New Names, and Reach for displaying views related to the subscriber's connections, channels and content.

The analytics module 197 is configured to provide business intelligence to the subscribers. Business intelligence output is provided to customers across the value chain of the marketplace content application 110. The output may include which content material is generating engagement activity, how the different accounts stack up or compare, and metrics across the subscriber accounts. Other types of business intelligence output may be used on alternative embodiments.

The segmentation module 195 is configured to provide filtering related to the delivery scope of the uploaded compliant content based on metadata. In various embodiments, the segmentation module 195 is managed by the content provider. During the upload process of new compliant content, the content provider may use various meta attributes available to him or her to target the delivery of the uploaded compliant content to a specific audience of individual subscribers. The segmentation module 195 accesses information from meta attribute table 411 to filter the scope of delivery based on certain criteria. The content providers generate the segments based on meta attributes available to them. In some embodiments, information from the user profiles may be used to generate segments, and in other embodiments, information from both the user profiles and the meta attributes in the meta attribute table 411 may be used to generate segments.

In an example, a content provider may generate a segment for all users whose email address contains the word “apple” to have access to a specific uploaded compliant content. In another example, the content provider would like to restrict access (to an uploaded compliant content) to only those users having a security license. In other words, only users with a security license can view or access a particular uploaded compliant content. In this example, the segmentation module 195 may generate a segment based on intrinsic data about a user (available from either the user profile or meta attribute table 144). In another example, the content provider may generate a segment to restrict access to a particular uploaded compliant content to users who belong to the gold club of a company. This segment may be generated using non-instrinsic metadata. The metadata may be referred to as relationship metadata because it is descriptive of a relationship a user has with a company. In these three examples, the “user” may be an individual who is a subscriber or a non-subscriber of the multi-tenant publishing system 100. Also, the “company” may refer to an entity which is a subscriber or a non-subscriber of the multi-tenant publishing system 100.

The activity module 194 is configured to index and provide feeds to the individual subscribers. In one embodiment, the feeds are viewed by the individual subscribers in a dashboard referred to as a user wall. The distributed new compliant content (uploaded by the content providers) is made available to a group of filtered individual subscribers. Each new piece of compliant content uploaded into the multi-tenant publishing system 100 is tagged with content metadata that is used to determine the target audience of the newly uploaded compliant content. Once the target audience of the newly uploaded compliant content is identified (i.e., the group of filtered individual subscribers), the activity module 194 updates the feeds of the individual subscribers within the group of filtered individual subscribers. The activity module 194 makes the newly uploaded compliant content visible or available to those individual subscribers.

For various embodiments, policy provided and managed by the governing entity subscribers is also considered in the distribution of the approved compliant content via activity feeds. For example, a content provider (from Company A) selects Company B to receive version X of the uploaded compliant content. However, Company B has indicated through the handshake functionality that a handshake between Company A and B is denied. In other words, Company B does not view Company A as a trusted company and does not allow the individual subscribers that Company B manages to have access to any compliant content uploaded by Company A. In this example, the individual subscribers managed by Company B are blocked from accessing the uploaded compliant content, even though Company A has approved access to the individual subscribers associated with Company B.

Referring back to FIG. 1D, the policy module 196 is configured to provide functionality to implement business rules associated with the corporate policies of the various entity subscribers. The policies are based on the relationships specified by the relationship metadata shown in FIG. 4B. In some embodiments, the individual subscribers who are managed by one or more managing entity subscribers may adhere to the corporate policies of their managing entity subscribers. FIGS. 2C, 2D and 2E provide some examples of business relationships between entity subscribers and individual subscribers.

FIG. 2C illustrates a diagram 220 of an entity subscriber 221 with individual subscribers 222-225 working for the entity subscriber 221 as an employee or a contractor. In this example, the entity subscriber 221 is a managing entity subscriber that specifies that the individual subscribers 222-225 adhere to its corporate policies related to the sharing of uploaded compliant content. In other words, the individual subscribers 222-225 are governed by the corporate policy of the entity subscriber 221. In this example, subscribers 222-225 are not associated with other entity subscribers.

FIG. 2D illustrates an example diagram 230 of an entity subscriber 232 operating as a branch or subsidiary of the entity subscriber 231. An individual subscriber 233 has a business relationship with the entity subscriber 232 as either an employee or contractor. The entity subscriber 232 is not associated with other entity subscribers. In this example, the entity subscriber 232 is a managing entity subscriber of the individual subscriber 233 who is required to adhere to the corporate policy of the entity subscriber 232. The corporate policy of the entity subscriber 232 may require the individual subscriber 233 to also follow some or all of the corporate policies of its parent company (i.e., the entity subscriber 231) or may adopt the corporate policies of its parent company (or a portion of it) as its own corporate policy.

FIG. 2E illustrates an example diagram 240 where an individual subscriber 241 is associated with multiple entity subscribers 242-244. Some of the entity subscribers 242-244 are managing entity subscribers of the individual subscriber 241. The multi-tenant publishing system 100 distinguishes between a primary relationship between entity subscribers and individual subscribers, and a lightweight relationship between the entity subscribers and the individual subscribers. If an individual subscriber has a primary relationship with the entity subscriber, then the entity subscriber is a managing entity subscriber. On the other hand if the individual subscriber has a lightweight relationship with the entity subscriber, then the entity subscriber is referred to as a non-managing entity subscriber, where the individual subscriber is not governed by the corporate policies of the non-managing entity subscriber.

As shown in FIG. 2E, the individual subscriber 241 is associated with three entity subscribers 242-244. Two of the entity subscribers 242-244 are managing entity subscribers (i.e., the managing entity subscriber 242 and the managing entity subscriber 244). Also associated with the individual subscriber 241 is the non-managing entity subscriber 243. The individual subscriber 241 is governed by the corporate policies of the managing entity subscribers 242 and 244.

In one example, the individual subscriber 241 may be a financial advisor working as a registered representative or a broker-dealer (e.g., managing entity subscriber 242). The financial advisor may simultaneously be a registered investment advisor working for the managing entity subscriber 244. In this example, the individual subscriber 241, working in two different capacities associated with different managing entity subscribers 242, 244, may be governed by the corporate policies of the managing entity subscriber 242 and the managing entity subscriber 244.

A corporate policy of an entity subscriber governs all individual subscribers of the entity subscriber once it has been established that the individual subscribers have a primary relationship with the entity subscriber. The corporate policy may include a number of business rules related to what actions individual subscribers may perform related to the delivery of the uploaded compliant content. For example, various business rules are related to further engagements with subscribers and non-subscribers such as who the individual subscribers can share the uploaded compliant content with, how the individual subscribers share (e.g., what delivery channel) the uploaded compliant content, and whether the individual subscribers can add comments to the uploaded compliant content. Numerous other business rules may be included within a business policy related to the delivery or sharing of uploaded compliant content.

In various embodiments, the corporate policy of an entity subscriber applies only to individual subscribers filtered by the segmentation module 195, also referred to as the group of filtered individual subscribers (associated with uploaded compliant content). The policy module 196 applies governing corporate policies only to this group of filtered individual subscribers.

In an example embodiment, the handshake functionality of the multi-tenant publishing system 100 may be implemented in the policy module 196. FIGS. 3A-3B illustrate a handshake between two entity subscribers A 301 and entity subscriber B 302. In the example shown in FIG. 3A, the handshake 304 represents a one-way handshake. The entity subscriber A 301 may share uploaded compliant content with the entity subscriber B 302, and the managed individual subscribers 303 of the subscriber entity B 302 may have access to uploaded compliant content from the entity subscriber 301. In other words, the entity subscriber B 302 trusts the entity subscriber A 301 with respect to the delivery of compliant content. However, the entity subscriber B may not share uploaded compliant content with the entity subscriber A 301. In the example shown in FIG. 3B, the handshake shown in FIG. 3B is a mutual handshake 305 and both entity subscriber A 301 and entity subscriber B 302 trust each other regarding the delivery of compliant content to their individual managed subscribers 303 and 306, respectively.

In an example embodiment, system administrators associated with the entity subscriber A 301 an the entity subscriber B 302 may use a handshake view in a user interface of the multi-tenant publishing system 100 to search for other companies that it would like to request a handshake with. For example, in FIG. 3A, the entity subscriber A 301 makes a handshake request to the entity subscriber B 302 to allow it to share compliant content. The entity subscriber B 302 may accept the handshake request or deny the handshake request from the entity subscriber A 301. In another example (shown in FIG. 3A), the entity subscriber B 302 may make the handshake request to have entity subscriber A 301 share compliant content with the entity subscriber B 302. The entity subscriber A 301 may accept the request or deny the request. In other examples, both entity subscribers A and B may agree to a mutual handshake 305, shown in FIG. 3B. The mutual handshake 305 may be requested by either the entity subscriber A 301 or the entity subscriber B 302, and accepted by the other entity before the mutual handshake 305 can be implemented by the multi-tenant publishing system 100.

Referring to FIG. 1D, the authorization module 193 is configured to authorize the delivery (sharing or re-sharing) of the uploaded compliant content based on information provided by the identity management module 192. The identity management module 192 is involved in both the first stage and the second stage of managing the delivery of uploaded compliant content. Authorization to upload compliant content and provide access to the filtered individual subscribers is generally governed by the first stage (i.e. the scope defining stage). Authorization for the filtered individual subscribers to re-share the uploaded compliant content and engage in further activity related to re-sharing the uploaded compliant content is generally governed by the second stage (i.e., policy stage).

Referring to FIG. 1D, the publishing module 199 provides functionality for online publication of compliant content. The publication of compliant content may be done through a number of publishing channels 140 (FIG. 1A). This includes uploading new compliant content, sharing the new compliant content and re-sharing the compliant content. Every time a new compliant content is uploaded by a content provider, the publishing module 199, evaluates the content metadata associated with the newly uploaded compliant content (shown in FIG. 4C) and meta attributes in the meta attribute table 411 (shown in FIG. 4B in diagram 410). In various embodiments the content metadata is mapped to the meta attributes in the meta attribute table 411 (shown in FIG. 4E). Based on the meta attributes and the relevant corporate policies, the activity feeds are updated based on the applicable meta attributes. The publishing module 199, together with the identity management module 192 and the policy module 196, provide publishing functionality to the multi-tenant publishing system 100 in various embodiments. For example, the identity management module 192 may be associated with the scope defining stage and the policy module 196 may be associated with the policy stage.

The identity management module 192 provides functionality to manage information related to subscribers (individual and entity), and their relationships. The identity management module 192 has access to a user profile table 401 (shown in FIG. 4A), which may be stored in the main data store 160 in an example embodiment. The user profile table 401 includes a profile for each individual subscriber (current or former) of the multi-tenant publishing system 100. Metadata from a meta attribute table 411 (shown in FIG. 4B) may be associated with each individual user. For example, a number of meta attributes may be keyed to an individual subscriber. In some embodiments, the identity management module 192 together with the segmentation module 195 performs segmentation to produce one or more segments of individual subscribers who have access to uploaded compliant content. In some examples, the identity management module 192 may be considered to define the delivery scope (and any applicable content scope) based on metadata. The metadata may be associated with the uploaded compliant content or the metadata associated with the individual subscribers from the meta attribute table 411.

Once the group of filtered individual subscribers are identified by the identity management module 192, the policy rules applicable to those individual subscribers in the group of approved individual subscribers are identified and applied. The policy rules are managed by the entity subscriber by providing input into the multi-tenant publishing system 100. As described above, the policy rules are generated based on relationships between individual subscribers and entity subscribers. An individual subscriber may be governed by more than one managing entity subscriber.

The publishing module 199 publishes content after the identity management module 192 identifies the group of filtered individual subscribers having access to the uploaded compliant content and after the policy module 196 applies the business rules of any governing corporate policies associated with the individual subscribers from the group of filtered individual subscribers. In various embodiments, the publishing of uploaded compliant content relies on metadata associated with individual subscribers and corporate polices.

FIGS. 3C and FIG. 3D further illustrate delivery of uploaded compliant content by multiple subscribers. The diagram 320 illustrates the delivery of uploaded compliant content by publishers who have established handshakes with the content provider. The entity subscribers 331-334 represent content providers 330. The entity subscribers 341-348 represent publishers. The handshakes 351-354 represent one-way handshakes between the various content provider entity subscribers 331-334 and the publishing entity subscribers 341-344. The handshakes 355-359 represent mutual handshakes such that entity subscribers 345-348 may also be content providers with the entity subscribers 345-348 associated with the handshakes 355-359. The handshakes 351-359 represent understandings between two entity subscribers and may be incorporated into the corporate polices of the entity subscribers.

The entity subscriber 331 has one mutual handshake 359. The entity subscriber 332 has three handshakes: two mutual handshakes 358 and 357 and one one-way handshake 353. The entity subscriber 333 also has three handshakes: two one-way handshakes 351 and 352 and a single mutual handshake 356 The entity subscriber 334 has two handshakes: one-way handshake 354 and a mutual handshake 355. Based on information provided by the content providers 330 (e.g., content metadata) and established handshakes, the entity subscribers 341-348 (referred to as publishers) may engage with other subscribers and non-subscribers to share the uploaded compliant content in accordance with any governing corporate policies. The entity subscribers 341-348, governed by their corporate policy, provide delivery of the compliant content. In various embodiments, managed individual subscribers associated with the entity subscribers 341-348 publish on behalf of the entity subscribers 341-348 and individual subscribers associated with the entity subscribers 331- 334 upload the compliant content on behalf of the entity subscribers 341-348.

The diagram 360 shown in FIG. 3D illustrates various entity subscribers re-sharing the uploaded compliant content with either subscribers or non-subscribers in an example embodiment. The content providers 370 include the entity subscribers 371 and 372, which have some established handshakes between the publishers (including the entity subscriber 381, the entity subscriber 382, and the entity subscriber 391).

In this example, a handshake 373 is between the entity subscriber 371 and the entity subscriber 381, and a handshake 374 is between the entity subscriber 372 and the entity subscriber 382. However, there is no established handshake between the entity subscriber 372 and the entity subscriber 391. The entity subscriber 391 may still have access to uploaded compliant content from the entity subscriber 372 if the entity subscriber 372 did not deny a request form the entity subscriber 372 to share the uploaded compliant content. Once identified by the identity management module 192 to have approved access to the uploaded compliant content, the entity subscriber 391 may re-share or publish the uploaded compliant content consistent with the business rules from its governing corporate policy of the entity subscriber 391.

In the diagram 360, the circles with an “S” represent subscribers and the triangles with an “NS” represent non-subscribers. In this example, the entity subscriber 391 publishes directly to a group of non-subscribers 390. The entity subscribers 381 and 382 re-share the uploaded compliant content with other subscribers 383-388, and the other subscribers 383-388 then re-share or publish to the group of non-subscribers 390. Multiple online publishing channels 140 are available to publish the uploaded compliant content, for example via email, social networks, websites, and individual subscriber dashboards in various embodiments.

Referring back to FIG. 1D, the publishing module 199 relies on user specified input from two sources: (1) the content provider, in the form of content metadata associated with the compliant content uploaded; and (2) the entity subscriber managing an individual subscriber, from the group of filtered individual subscribers who have access the uploaded compliant content, in the form of corporate policies. From a very high level, the corporate policies govern the actions of managed individual subscribers and the suitability of the uploaded compliant content for sharing with other organizations (e.g., entity subscribers). In various embodiments, the publishing module 199 also relies on any available handshakes between entity subscribers. The handshakes may be considered part of the corporate policy. For example a handshake rule established by an entity subscriber referred to as Company A may indicate that any uploaded compliant content from a Company B should be blocked and not accessible to individual subscribers associated with a Company A.

The segmentation module 195 is configured to provide functionality to filter out group of subscribers based on specific meta attributes available to the content provider. The specific meta attributes are provided by the identity management module 192 to the segmentation module 195. The meta attributes provided by the content provider are used for filtering to define the individual subscribers who have access to the uploaded compliant content. The segmentation module 195 may use the specific meta attributes associated with contact information (e.g., email address domain) of individual subscribers to apply a filter for a specific company. For example, all individual subscribers who have a domain of morganstanley.com are segmented into a group of

Morgan Stanley employees. Segmentation is used to identify a target audience, during the upload of new compliant content, in some embodiments. Segmentation may also be used to identify a target audience when re-sharing uploaded compliant content in accordance with any business rules of governing corporate policies.

Still referring to FIG. 1D, the metadata attribute module 191 collects, manages, and stores the meta attributes for subscribers of the multi-tenant publishing system 100. In other embodiments, the metadata attribute module 191 may provide some logic to process various meta attributes. For example, the metadata attribute module 191 may map content metadata associated with uploaded compliant content with meta attributes in the metadata attribute table 411 (shown in FIG. 4B) as illustrated in FIG. 4E. In some embodiments, the metadata attribute module 191 may also identify conflicting attributes (either alone or in combination with the governance logic 625 shown in FIG. 6B). In some embodiments, the governance logic 625 may be (partly or fully) implemented by the metadata attribute module 191.

The meta attributes for subscribers are stored in the meta attribute table 411. As shown in FIG. 4B, the meta attribute table 411 may include user metadata 412, representing a collection of meta attributes intrinsic to a specific user or individual subscriber), relationship metadata 413 (collection of meta attributes specifying relationships between subscribers), and other metadata (collection of other meta attributes). The meta attribute table 411 represents metadata for all subscribers, including individual subscribers and entity subscribers. Some of the intrinsic user attributes may be included as part of the user profile of an individual subscriber. The user profile may also have various other intrinsic and non-intrinsic meta attributes associated with the user profile of an individual subscribers. A number of meta attributes are keyed to the individual subscribers.

As indicated above, the meta attribute table 411 includes various types of metadata including user metadata 412, relationship metadata 413, and other metadata 414. The meta attributes may be provided by a number sources as shown in FIGS. 5A-5C.

The multi-tenant publishing system 100 creates a comprehensive meta attribute table with numerous attributes keyed to the subscribers. Examples of attributes includes user (or individual subscriber) information such as registration or license numbers and licensed status, employment history, publishing permission (e.g., publish LinkedIn has a value of “true”), priority level associated with the data source (e.g., the most trusted data source has a 1, which may be user-specified information), KloutScore (i.e., how influential an individual subscriber is online), and email address. Furthermore, additional information may be inferred from the meta attributes associated with individual subscribers. For example, if an individual subscriber has an email address with a domain of MorganStanley, it can be inferred that Morgan Stanley is a managing entity subscriber of the individual subscriber. Furthermore, if the individual subscriber has a registration number with FINRA or a national securities exchange with an “active” status, it may be inferred that the individual subscriber is a licensed financial advisor. As the number of meta attributes related to individual subscribers increases, more information may be inferred about the individual subscribers.

The meta attributes for an individual subscriber may provide the individual subscriber with a portable identity that can be made available to other subscribers of the multi-tenant publishing system 100. The portable identity may be particularly useful to licensed professionals 173 (FIG. 1B), such as financial advisors, as their associations or relationships with other subscribers change. For example, a financial advisor A is licensed to work with Company A and Company B, which are mutual fund companies. The financial advisor A would also like to be licensed to do business with Company C, an insurance company. If company C is a subscriber of the multi-tenant publishing system 100, Company C may be provided with access to the user profile of the financial advisor A to evaluate the qualifications, background, and other available information from the multi-tenant publishing system 100 of the financial advisor A as a potential business partner. The user profile of the financial advisor A is associated with many meta attributes intrinsic to the financial advisor A. The portable identity allows information about subscribers to be shared with other subscribers based on meta attributes intrinsic to an individual subscriber.

Referring now to FIG. 5A, illustrates a diagram 500 with various entity subscribers that may provide meta attributes for the individual subscribers, in particular any individual subscribers the entity is managing. Entity A 501, entity B 502, entity C 503 and entity D 504 represent entity subscribers that provide intrinsic user metadata associated with individual subscribers. In the example shown in FIG. 5A, meta attributes associated with an individual user are aggregated from four entities (501-504), each providing meta attributes used to build the portion of the meta attribute table 411 associated with the individual subscriber. The user metadata set 1 506, the user metadata set 2 507, the user metadata set 3 508 and the user metadata set 4 509 are added to the meta attribute table 411 generally as intrinsic meta attributes of an individual subscriber. The company provided metadata 505 illustrates a summary table including the collection of meta attributes for all four companies are referred to as entities 501-504. The various entities 501-504 provide only intrinsic meta attributions related to the individual subscribers. Proprietary (to the entity) meta attributes are not collected by the meta attribute module 191.

FIG. 5B illustrates a diagram 530 representing an example of different types of data sources providing meta attributes associated with the individual subscribers. The table of metadata from multiple data sources 534 includes a data source field 536 and a data set field 537. This table of metadata from multiple data sources 534 is used to illustrate that multiple data sources provide sets of metadata attributes associated with individual subscribers. The meta attributes provided by the various data sources shown in FIG. 5B are collected and added to the meta attribute table 411. The company data 531 represents the first set of user metadata attributes, the third party data 532 represents the second set of user metadata attributes, the user provided data 533 represents a third set of user metadata attribute, and the government data 535 represents a fourth set of data.

FIG. 5C illustrates example tables 550 of company data meta attributes 561 and government data meta attributes and 571 that provide metadata from multiple data sources to box 551. The company data 560 provides a first set of user metadata attributes 552, representing intrinsic user data. The fourth set of user metadata attributes 553 may be either public or purchased data.

Referring to FIG. 4E, the block diagram 450 represents two separate stages in managing the delivery of uploaded compliant content. The first stage may be referred to as the scope defining stage and the second stage may be referred to as the policy stage.

During the first stage, the content providers manage the delivery of the uploaded compliant content based on segmentation using meta attributes. The content providers generate segments based on available meta attributes when they upload new compliant content.

During the second stage, the companies that manage those individual subscribers who have access to the uploaded compliant content also mange what those individual subscribers do with the uploaded compliant based on their corporate policies. In other words, during the second stage, the corporate policies are applied to the group of filtered individual subscribers to govern their actions pertaining to the delivery or re-sharing of the uploaded compliant content. The individual subscriber may have multiple entities governing their actions related to the delivery (or re-sharing) of the uploaded compliant content. In some situations, there may be a conflict between the policies of the governing entity subscribers. As such, authorization to access uploaded compliant content to share or re-share is managed by both the content provider and companies managing the individual subscribers.

In example embodiments and referring again to FIG. 1D, one or more of the meta attribute module 191, the identity management module 192, the segmentation module 195 and the suggestion module 198 may be involved in implementing the first stage. In other example embodiments, the identity management module 192, the policy module 196 and publishing module 199 may be involved in implementing the second stage. Other modules shown in FIG. 1D may also be involved in either the first stage or the second stage or both stages in various other embodiments.

In the example shown in FIG. 4E, content metadata 451 for compliant content is provided by the content provider. In this example, the uploaded compliant content includes two versions of a document. Version 1 (designated by 452) is to be shared with company A according to the content metadata 451, and version 2 (designated by 453) is to be shared by company B. The content metadata 451 includes meta attributes that are mapped to the meta attributes from the meta attribute table 411 to generate the segments to share version 1 (452) with company A and version 2 (453) with company B.

The segment generated for version 1 (452) includes USER1, USER2 and USER3 from company A. The meta attributes 461 are associated with USER1, the meta attributes 462 are associated with USER2, and the meta attributes 463 are associated with USER3.

The segment generated for version 2 (453) includes USER4, USER5 and USER6 from company B. The meta attributes 465 are associated with USER1, the meta attributes 466 are associated with USER2, and the meta attributes 467 are associated with USER3. The meta attributes 461 and 464 used to generate these segments may be the domains of the email addresses associated with company A and company B. The content metadata 451 may include a first attribute representing all users having the domain of company A for the sharing of version 1 (452) and a second attribute representing users having the domain of company B (464) for the sharing of version 2 (453). The first and second attributes from the content metadata 451 are mapped to meta attributes from the meta attribute table 411. The meta attribute table 411 includes the meta attributes associated with all subscribers of the multi-tenant publishing system 100. The criteria provided by the content provider is mapped to the attributes in the meta attribute table 411.

In various embodiments, the meta attribute module 191 identifies the group of filtered individual subscribers based on the mapping. The individual subscribers in that group have access to the uploaded compliant content. For example, the group of USER1, USER2, and USER3 has access to version 1 (452) of the uploaded compliant content. The meta attribute module 191 uses the relationship metadata from the metadata attributes 461-463 to determine which entity subscribers manage the individual subscribers in order to determine the applicable governing corporate policies. As shown in FIG. 4E, Company A policy 470 governs USER1, USER2 and USER3, and Company B policy 480 governs USER4, USER5 and USER6.

In the event that there is a conflict between the corporate policies of two managing subscriber entities of an individual subscriber, the suggestion module 198 may be used to govern the actions of the individual subscriber related to the conflict and help to resolve the conflict. FIGS. 6A-6D illustrate various aspects of governance of individual subscribers by multiple entity subscribers and resolving conflicts associated with governance by multiple entity subscribers. FIG. 6A illustrates a diagram 600 with three entity subscribers 601, 602 and 605 governing a single individual subscriber 604. The entity subscribers 601, 602 and 605 have a primary relationship with the individual subscriber 604 as their managing entity. The individual subscriber 604 is responsible for complying with the corporate policies of all three managing entity subscribers 601, 602 and 605. The governance of the individual subscriber 604 is based on policy imposed by each of the managing entity subscribers 601, 602 and 605 and scope as defined by the meta attributes in the metadata table 411 associated with the individual subscriber 604.

Referring to FIG. 4D, a diagram 440 illustrates a policy table 441. For one embodiment, the policy table 441 represents a policy table for all entity subscribers. In this example, the policy for three companies are shown (e.g., the three managing entity subscribers 601, 602 and 605). The policy 442 represents the policy for company A used for managing individual subscribers. The policy 443 represents the policy for company A used for managing individual subscribers. The policy 444 represents the policy for company A used for managing individual subscribers.

FIG. 6B illustrates in an example diagram 610 of conflicting attributes 613 associated with an individual subscriber. The conflicting attributes 613 are associated with an individual subscriber and provided by different sources. The individual subscriber has associated meta attributes which includes meta attributes related to: (1) entity subscriber A provided attributes 611 and (2) entity subscriber B provided attributes 612. The attributes 611 and 612 may have been provided from different sources. The attributes in conflicting attributes 613 may be related to the number of times an individual may publish uploaded complaint content. The entity subscriber A may have provided meta attributes indicating the individual subscriber can only publish the uploaded compliant content to 10 people, whereas the entity subscriber B may have meta attributes indicating the individual subscriber can publish the uploaded compliant content to 100 people.

FIG. 6C illustrates a diagram 640 representing governance logic 625 for resolving attributes in conflict. The governance logic 625 includes a conflict determination module 621, a resolution determination module 622 and an update module 623. The conflict determination module 621 determines conflicting attributes. In some embodiments, entity subscribers that provide meta attributes intrinsic to an individual subscriber may provide such data in a standardized format with pre-determined fields and formats. The standardized format makes it easier to compare meta attributes from multiple sources and identify conflicting attributes.

The resolution determination module 622 determines a possible resolution. For example, the resolution determination module 622 may compare the meta attributes and select the more conservative of the two conflicting attributes. In the example provided above, the resolution determination module 622 may select the meta attributes provided by company A allowing only 10 publications (as compared to 100 publications). The resolution determination module 622 may also rely on the suggestion module 198 to suggest user provided feedback to reconcile conflicting attributes. The suggestion module 198 may suggest that an individual subscriber update certain meta attributes, confirm certain meta attributes, or add certain meta attributes. Generally, the suggestion module 198 makes suggestions based on credible information as determined by a relevancy score or weighting.

FIG. 6D may be used to illustrate an example of conflicting attributes related to an individual subscriber. The user metadata table 640 includes a priority level field 641, a source field 642, an attribute name field 643, and an attribute value field 644. The priority level field 641 based on the information in the source field 642. The more trusted a source is, the higher the priority level field 641 value is. For example, if the meta attribute is provided by the user, a priority level of 1 is assigned to that attribute in this example. If the meta attribute is provided by a company such as an entity subscriber, then a priority level of 2 is assigned to that attribute in this example. Assume that for this example, rows 645 and 646 are associated with the same individual subscriber. The meta attributes in these rows are related to an attribute called the

CRD KEY. The CRD KEY may represent the SEC/FINRA identification (ID) number. However, the attribute value provided by the user is different from the attribute value provided by the company. The conflict determination module 621 may determine there is a conflict and the resolution determination module 622 may rely on the suggestion module 198 to ask the individual subscriber (e.g., USER) which of the two values in the table 640 is the correct CRD KEY value.

In this example, if the user responds to the suggestion presented by the suggestion module 198, the multi-tenant publishing system 100 identifies this information as priority level 1 information and updates the user profile (or relevant meta attributes) with the updates provided by the individual subscriber. This updated information then becomes available to the various subscribers of the multi-tenant publishing system 100.

FIGS. 7A-7D illustrate flow diagrams for various embodiments to deliver uploaded compliant content using the multi-tenant publishing system 100. In example embodiments, the flow diagrams of methods 700-730 may be implemented using one or more modules of the multi-tenant publishing system 100 (shown in FIG. 1D). In alternative embodiments, additional operations may be added to each of the methods 700-730, or one or more operations may be deleted from each of the methods 700-730. In further embodiments, the operation of methods 700-730, or variants of these flow diagrams, may be combined.

FIG. 7A illustrates a flow diagram of a method 700 for delivering uploaded compliant in two stages, according to an example embodiment. At operation 701, a scope is defined (by a content publisher) related to the sharing of uploaded compliant content by individual subscribers of the multi-tenant publishing system 100 based on metadata associated with the individual subscribers. At operation 702 engagement activity of the individual subscribers who have access to the uploaded compliant content related to the re-sharing of the uploaded compliant content based on corporate policies governing the individual subscribers is managed (indirectly by the governing entities).

FIG. 7B illustrates a flow diagram of a method 710 to define the scope for delivering uploaded compliant content, according to an example embodiment. At operation 711, a segment is generated (by a content publisher) representing a group of filtered individual subscribers to have access to uploaded compliant content based on metadata. At operation 712, the individual subscribers in the group of filtered individual subscribers are provided with access to the uploaded compliant content.

FIG. 7C illustrates a flow diagram of a method 720 to for delivering uploaded compliant content based on governing corporate policies. At operation 721, identifying managing entity subscribers of the individual subscribers in the group of filtered individual subscribers based on metadata. At operation 722 identifying corporate policies of the managing entity subscribers governing the individual subscribers in the group of filtered individual subscribers. At operation 723, managing further engagement activity related to the uploaded compliant content of the individual subscribers in the group of filtered individual subscribers based on the governing corporate polices of the individual subscribers in the group of filtered individual subscribers.

FIG. 7D illustrates another example of a flow diagram of a method 730 to for delivering uploaded compliant content. At operation 731, compliant content having associated content metadata uploaded into the multi-tenant publishing system 100 is identified, the multi-tenant publishing system 100 including individual subscribers and entity subscribers, the content metadata including meta attributes specifying a delivery scope and a content scope. At operation 732, a meta attribute table including meta attributes representing user metadata associated with individual subscribers and relationship metadata specifying at least one managing entity subscribers of the individual subscribers is accessed, the meta attributes including meta attributes from multiple types of data sources. At operation 733, a group of filtered individual subscribers is identified to access the uploaded compliant content by mapping the content metadata to the meta attributes in the meta attribute table. At operation 734, update feeds are provided to the group of the filtered individual subscribers to provide access to the uploaded compliant content. At operation 735, at the least one managing entity subscribers associated with the individual subscribers from the group of filtered individual subscribers based on the meta attributes, each of the managing entity subscribers having a corporate policy governing online delivery of the uploaded compliant content by the individual subscribers from the group of filtered individual subscribers managed by each of the managing entity subscribers are identified. At operation 736, activity feeds are updated in response to delivery requests by the individual subscribers from the group of approved individual subscribers to publish the uploaded compliant content in accordance with the corporate policies of any managing entity subscribers of the individual subscribers from the group of filtered individual subscribers.

### Modules, Components, and Logic

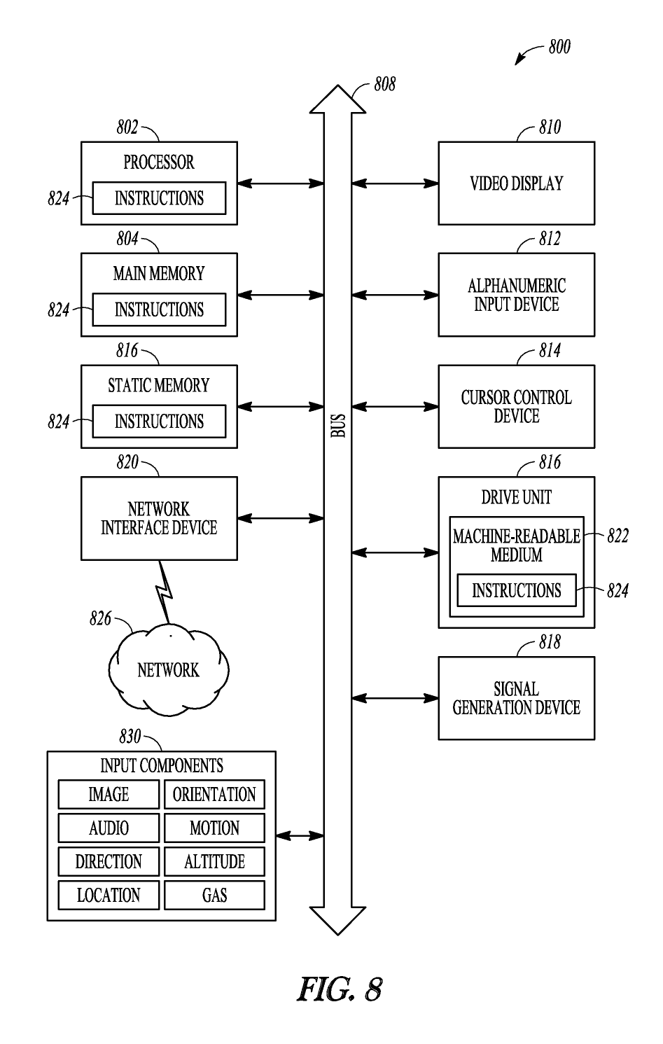

FIG. 8 is a block diagram illustrating components of a machine 800, according to some example embodiments, able to read instructions from a machine-readable medium (e.g., a machine-readable storage medium) and perform any one or more of the methodologies discussed herein. Specifically, FIG. 8 shows a diagrammatic representation of the machine 800 in the example form of a computer system, within which instructions 824 (e.g., software, a program, an application, an applet, an app, or other executable code) for causing the machine 800 to perform any one or more of the methodologies discussed herein may be executed. In alternative embodiments, the machine 800 operates as a standalone device or may be connected (e.g., networked) to other machines.

In a networked deployment, the machine 800 may operate in the capacity of a server machine or a client machine in a server-client network environment, or as a peer machine in a peer-to-peer (or distributed) network environment. The machine 800 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 824, sequentially or otherwise, that specify actions to be taken by that machine. Further, while only a single machine 800 is illustrated, the term “machine” shall also be taken to include a collection of machines 800 that individually or jointly execute the instructions 824 to perform any one or more of the methodologies discussed herein.

The machine 800 includes a processor 802 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 804, and a static memory 806, which are configured to communicate with each other via a bus 808. The machine 800 may further include a video display 810 (e.g., a plasma display panel (PDP), a light emitting diode (LED) display, a liquid crystal display (LCD), a projector, or a cathode ray tube (CRT)). The machine 800 may also include an alphanumeric input device 812 (e.g., a keyboard), a cursor control device 814 (e.g., a mouse, a touchpad, a trackball, a joystick, a motion sensor, or other pointing instrument), a storage unit 816, a signal generation device 818 (e.g., a speaker), and a network interface device 820.

The storage unit 816 includes a machine-readable medium 822 on which is stored the instructions 824 embodying any one or more of the methodologies or functions described herein. The instructions 824 may also reside, completely or at least partially, within the main memory 804, within the static memory 806, within the processor 802 (e.g., within the processor's cache memory), or all three, during execution thereof by the machine 800. Accordingly, the main memory 804, static memory 806 and the processor 802 may be considered machine-readable media 822. The instructions 824 may be transmitted or received over a network 826 via the network interface device 820.

In some example embodiments, the machine 800 may be a portable computing device, such as a smart phone or tablet computer, and have one or more additional input components 830 (e.g., sensors or gauges). Examples of such input components 830 include an image input component (e.g., one or more cameras, an audio input component (e.g., one or more microphones), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components 830 may be accessible and available for use by any of the modules described herein.

As used herein, the term “memory” refers to a machine-readable medium 822 able to store data temporarily or permanently and may be taken to include, but not be limited to, random-access memory (RAM), read-only memory (ROM), buffer memory, flash memory, and cache memory. While the machine-readable medium 822 is shown in an example embodiment to be a single medium, the term “machine-readable medium” should be taken to include a single medium or multiple media (e.g., a centralized or distributed database, or associated caches and servers) able to store instructions 824. The term “machine-readable medium” shall also be taken to include any medium, or combination of multiple media, that is capable of storing instructions (e.g., instructions 824) for execution by a machine (e.g., machine 800), such that the instructions, when executed by one or more processors of the machine 800 (e.g., processor 802), cause the machine 800 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory, an optical medium, a magnetic medium, or any suitable combination thereof. The term “machine-readable medium” specifically excludes non-statutory signals per se.

Furthermore, the machine-readable medium 822 is non-transitory in that it does not embody a propagating signal. However, labelling the machine-readable medium 822 as “non-transitory” should not be construed to mean that the medium 822 is incapable of movement; the medium 822 should be considered as being transportable from one physical location to another. Additionally, since the machine-readable medium 822 is tangible, the medium 822 may be considered to be a machine-readable device.

The instructions 824 may further be transmitted or received over a communications network 826 using a transmission medium via the network interface device 820 and utilizing any one of a number of well-known transfer protocols (e.g., hypertext transfer protocol (HTTP)). Examples of communication networks include a local area network (LAN), a wide area network (WAN), the Internet, mobile telephone networks (e.g. 3GPP, 4G LTE, 3GPP2, GSM, UMTS/HSPA, WiMAX, and others defined by various standard setting organizations), plain old telephone service (POTS) networks, and wireless data networks (e.g., WiFi and BlueTooth networks). The term “transmission medium” shall be taken to include any intangible medium that is capable of storing, encoding, or carrying instructions 824 for execution by the machine 800, and includes digital or analog communications signals or other intangible medium to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium 822 or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field-programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor (e.g., processor 802), for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors 802 that are temporarily configured (e.g., by software) or permanently configured to perform the relevant operations. Whether temporarily or permanently configured, such processors 802 may constitute processor-implemented modules that operate to perform one or more operations or functions described herein. As used herein, “processor-implemented module” refers to a hardware module implemented using one or more processors 802.

Similarly, the methods described herein may be at least partially processor-implemented, with a processor 802 being an example of hardware. For example, at least some of the operations of a method may be performed by one or more processors 802 or processor-implemented modules. Moreover, the one or more processors 802 may also operate to support performance of the relevant operations in a “cloud computing” environment or as a “software as a service” (SaaS). For example, at least some of the operations may be performed by a group of computers (as examples of machines 800 including processors 802), with these operations being accessible via the network 826 (e.g., the

Internet) and via one or more appropriate interfaces (e.g., an application program interface (API)).

The performance of certain of the operations may be distributed among the one or more processors 802, not only residing within a single machine 800, but deployed across a number of machines 800. In some example embodiments, the one or more processors 802 or processor-implemented modules may be located in a single geographic location (e.g., within a home environment, an office environment, or a server farm). In other example embodiments, the one or more processors 802 or processor-implemented modules may be distributed across a number of geographic locations.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

1. An access control system for publishing online content, comprising:
at least one hardware processor configured to perform operations for hardware processor-implemented modules including:
a scope defining stage module configured to:
generate a segment representing a group of filtered individual subscribers to have access to uploaded compliant content based on content metadata associated with the content, the content metadata including meta attributes specifying a delivery scope and a content scope; and
provide individual subscribers in the group of filtered individual subscribers with access to the uploaded compliant content; and
a policy stage module configured to:
identify managing entity subscribers of the individual subscribers in the group of filtered individual subscribers based on user metadata associated with the individual subscribers and the content metadata;
identify corporate policies of the managing entity subscribers governing the individual subscribers in the group of filtered individual subscribers; and
manage further engagement activity related to the uploaded compliant content of the individual subscribers in the group of filtered individual subscribers based on the governing corporate polices of the individual subscribers in the group of filtered individual subscribers, wherein the policy stage module further comprises:
a publishing module configured to:
receive share requests from the individual subscribers in the group of filtered individual subscribers; and
deliver the uploaded compliant content in response to the share requests based on authorization that the share requests are compliant with the governing corporate polices of the individual subscribers in the group of individual subscribers.

2. The system of claim 1, wherein the system represents a multi-tenant publishing system for delivery of online content.

3. The system of claim 1, wherein the scope defining stage module further comprises:
a metadata attribute module configured to maintain a meta attribute table including metadata associated with subscribers of the system, the subscribers including entity subscribers and individual subscribers of the system.

4. The system of claim 3, wherein the meta attribute table includes user metadata and relationship metadata.

5. The system of claim 3, wherein the scope defining stage module further comprises:
a segmentation module configured to generate the segment representing the group of filtered individual subscribers to have access to uploaded compliant content based on the metadata maintained by the metadata attribute module,
wherein the metadata attribute module is further configured to tag the metadata associated with the individual subscribers of the system with the metadata.

6. The system of claim 5,
wherein the scope defining stage module further comprises:
an identity management module configured to manage relationship information between the entity subscribers and the individuals subscribers of the system; and
wherein the metadata attribute module is configured to maintain the relationship information as relationship metadata in the meta attribute table.

7. The system of claim 1, wherein the policy stage module further comprises a policy module configured to:
maintain corporate policy information in the system for the entity subscribers to identify corporate policies of the managing entity subscribers governing the individual subscribers in the group of filtered individual subscribers.

8. (canceled)

9. The system of claim 1, further comprising an activity module configured to:
update activity feeds of the individual subscribers in the group of filtered individual subscribers to access the uploaded compliant content.

10. The system of claim 1, further comprising:
an activity module configured to update activity feeds of users specified in the share requests for re-sharing the uploaded compliant content to approved users, the approved users representing users that the governing corporate policies of the individual subscribers in the group of filtered individuals permits the individual subscribers in the group of the filtered individual subscribers to share the uploaded compliant content with.

11. A method for access control of online content, comprising:
identifying compliant content having associated content metadata uploaded into a multi-tenant publishing system, the multi-tenant publishing system including individual subscribers and entity subscribers, the content metadata including meta attributes specifying a delivery scope and a content scope;
accessing a meta attribute table including meta attributes representing user metadata associated with the individual subscribers and relationship metadata specifying at least one managing entity subscriber of the individual subscribers, the meta attributes including meta attributes from multiple types of data sources;
identifying a group of filtered individual subscribers to access the uploaded compliant content by mapping the content metadata to the meta attributes in the meta attribute table; and
updating feeds to a group of the filtered individual subscribers to provide access to the uploaded compliant content.

12. The method of claim 11, further comprising:
identifying at the least one managing entity subscriber associated with the individual subscribers from the group of filtered individual subscribers based on the meta attributes, each of the managing entity subscribers having a corporate policy governing online delivery of the uploaded compliant content by the individual subscribers from the group of filtered individual subscribers managed by each of the managing entity subscribers; and
updating activity feeds in response to delivery requests by the individual subscribers from the group of the filtered individual subscribers to publish the uploaded compliant content in accordance with the corporate policies of any managing entity subscribers of the individual subscribers from the group of filtered individual subscribers.

13. The method of claim 12, wherein updating the activity feeds in response to the delivery requests by the individual subscribers in the group of filtered individual subscribers further comprising:
delivering the uploaded compliant content to other subscribers in accordance with the corporate policies governing the individual subscribers in the group of filtered individual subscribers.

14. The method of claim 12, wherein updating the activity feeds in response to the delivery requests by the individual subscribers from the group of filtered individual subscribers further comprises:
delivering to non-subscribers the uploaded compliant content in accordance with the corporate policies governing the individual subscribers in the group of filtered individual subscribers.

15. The method of claim 11, wherein the content scope represents information related to a version of the uploaded compliant content.
Title: MULTI-TENANT PUBLISHING SYSTEM

16. The method of claim 11, wherein the delivery scope represents at least a subset of individual subscribers associated with one of the entity subscribers.

17. The method of claim 11, wherein the content metadata represents content provider specified data used to create the group of filtered individual subscribers who have access to the uploaded compliant content.

18. The method of claim 12, wherein the corporate policies governing the delivery of the uploaded compliant content by any of the individual subscribers from the group of filtered individual subscribers includes business rules related to a type of publishing channel used to deliver the uploaded compliant content.

19. The method of claim 12, wherein the corporate policies governing the delivery of the uploaded compliant content includes business rules related to handshake information.

20. The method of claim 19,
wherein the multi-tenant publishing system receives handshake configuration information from a representative of one of the entity subscribers indicating that the entity subscriber is trusted by the one of the entity subscribers.

21. The method of claim 12,
wherein an individual subscriber from the group of filtered individual subscribers is governed by multiple entity subscribers including a first governing entity subscriber and a second governing entity subscriber; and
further comprising:
identifying one or more conflicting meta attributes between the first governing entity subscriber and the second governing entity subscriber;
determining a resolution of the conflicting meta attributes; and
updating the meta attributes associated with the individual subscriber based on the resolution.

22. The method of claim 21, wherein determining the resolution of the conflicting meta attributes further comprises:
determining the resolution of the conflicting meta attributes based on the priority level associated with the meta attributes.

23. The method of claim 21,
wherein determining the resolution of the conflicting meta attributes further comprises:
suggesting to the individual subscribers to update the conflicting meta attributes;
receiving updated conflicting meta attribute information from the individual subscribers,
wherein updating the meta attributes associated with the individual subscribers further comprises:
updating the meta attributes associated with the individual subscribers who provided updated conflicting attribute information.

24. The method of claim 11, wherein the multiple types of data sources include one or more selections from a group consisting of: user-provided data, company-provided data, government-provided data, and third party-provided data.

25. A non-transitory machine-readable medium storing instructions that, when executed by at least one hardware processor of a machine, cause the machine to perform a method of providing access control for online content, the method comprising:
generating a segment representing a group of filtered individual subscribers to have access to uploaded compliant content based on content metadata associated with the content, the content metadata including meta attributes specifying a delivery scope and a content scope;
providing individual subscribers in the group of filtered individual subscribers with access to the uploaded compliant content;
identifying managing entity subscribers of the individual subscribers in the group of filtered individual subscribers based on user metadata for the individual subscribers and the content metadata;
identifying corporate policies of the managing entity subscribers governing the individual subscribers in the group of filtered individual subscribers;
managing further engagement activity related to the uploaded compliant content of the individual subscribers in the group of filtered individual subscribers based on the governing corporate polices of the individual subscribers in the group of filtered individual subscribers;
receiving share requests from the individual subscribers in the group of filtered individual subscribers; and
delivering the uploaded compliant content in response to the share requests based on authorization that the share requests are compliant with the governing corporate polices of the individual subscribers in the group of individual subscribers.
